(19) United States
(12) Patent Application Publication
(10) Pub. No.: US 2013/0086499 A1
(43) Pub. Date: Apr. 4, 2013

(54) PRESENTING AUXILIARY CONTENT IN A GESTURE-BASED SYSTEM

(71) Applicants: Matthew G. Dyor, Bellevue, WA (US); Royce A. Levien, Lexington, MA (US); Richard T. Lord, Tacoma, WA (US); Robert W. Lord, Seattle, WA (US); Mark A. Malamud, Seattle, WA (US); Xuedong Huang, Bellevue, WA (US); Marc E. Davis, San Francisco, CA (US)

(72) Inventors: Matthew G. Dyor, Bellevue, WA (US); Royce A. Levien, Lexington, MA (US); Richard T. Lord, Tacoma, WA (US); Robert W. Lord, Seattle, WA (US); Mark A. Malamud, Seattle, WA (US); Xuedong Huang, Bellevue, WA (US); Marc E. Davis, San Francisco, CA (US)

(21) Appl. No.: 13/330,371

(22) Filed: Dec. 19, 2011

Related U.S. Application Data
(63) Continuation-in-part of application No. 13/251,046, filed on Sep. 30, 2011.
Application No. 13/251,046 is a continuation-in-part of application No. 13/269,466, filed on Oct. 7, 2011.
Application No. 13/269,466 is a continuation-in-part of application No. 13/278,680, filed on Oct. 21, 2011.
Application No. 13/278,680 is a continuation-in-part of application No. 13/284,673, filed on Oct. 28, 2011.
Application No. 13/284,673 is a continuation-in-part of application No. 13/284,688, filed on Oct. 28, 2011.

(51) Int. Cl. G06F 3/048; G06N 5/04; G06Q 30/02

(52) U.S. Cl. 715/766; 715/764; 715/781; 705/14.49

(57) ABSTRACT

Methods, systems, and techniques for automatically providing auxiliary content are provided. Example embodiments provide a Gesture Based Content Presentation System (GBCPS), which enables a gesture-based user interface to present auxiliary content that is related to an portion of electronic input that has been indicated by a received gesture. In overview, the GBCPS allows a portion (e.g., an area, part, or the like) of electronically presented content to be dynamically indicated by a gesture. The GBCPS then examines the indicated portion in conjunction with a set of (e.g., one or more) factors to determine auxiliary content to present. Auxiliary content may be in many forms, including, for example, a web page, code, document, or the like. Once the auxiliary content is determined, it is then presented to the user, for example, using a separate panel, an overlay, or in any other fashion.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

### RELATED APPLICATIONS

For purposes of the USPTO extra-statutory requirements, the present application constitutes a continuation-in-part of U.S. patent application Ser. No. 13/251,046, entitled GESTURE BASED NAVIGATION TO AUXILIARY CONTENT, filed 30 Sep. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/269,466, entitled PERSISTENT GESTURELETS, filed 7 Oct. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/278,680, entitled GESTURE BASED CONTEXT MENUS, filed 21 Oct. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/284,673, entitled GESTURE BASED SEARCH SYSTEM, filed 28 Oct. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/284,688, entitled GESTURE BASED NAVIGATION SYSTEM, filed 28 Oct. 2011, which is currently co-pending, or is an application of which a currently co-pending application is entitled to the benefit of the filing date.

### TECHNICAL FIELD

The present disclosure relates to methods, techniques, and systems for providing a gesture-based system and, in particular, to methods, techniques, and systems for automatically presenting content based upon gestured input.

### BACKGROUND

As massive amounts of information continue to become progressively more available to users connected via a network, such as the Internet, a company intranet, or a proprietary network, it is becoming increasingly more difficult for a user to find particular information that is relevant, such as for a task, information discovery, or for some other purpose. Typically, a user invokes one or more search engines and provides them with keywords that are meant to cause the search engine to return results that are relevant because they contain the same or similar keywords to the ones submitted by the user. Often, the user iterates using this process until he or she believes that the results returned are sufficiently close to what is desired. The better the user understands or knows what he or she is looking for, often the more relevant the results. Thus, such tools can often be frustrating when employed for information discovery where the user may or may not know much about the topic at hand.

Different search engines and search technology have been developed to increase the precision and correctness of search results returned, including arming such tools with the ability to add useful additional search terms (e.g., synonyms), rephrase queries, and take into account document related information such as whether a user-specified keyword appears in a particular position in a document. In addition, search engines that utilize natural language processing capabilities have been developed.

In addition, it has becoming increasingly more difficult for a user to navigate the information and remember what information was visited, even if the user knows what he or she is looking for. Although bookmarks available in some client applications (such as a web browser) provide an easy way for a user to return to a known location (e.g., web page), they do not provide a dynamic memory that assists a user from going from one display or document to another, and then to another. Some applications provide “hyperlinks,” which are cross-references to other information, typically a document or a portion of a document. These hyperlink cross-references are typically selectable, and when selected by a user (such as by using an input device such as a mouse, pointer, pen device, etc.), result in the other information being displayed to the user. For example, a user running a web browser that communicates via the World Wide Web network may select a hyperlink displayed on a web page to navigate to another page encoded by the hyperlink. Hyperlinks are typically placed into a document by the document author or creator, and, in any case, are embedded into the electronic representation of the document. When the location of the other information changes, the hyperlink is “broken” until it is updated and/or replaced. In some systems, users can also create such links in a document, which are then stored as part of the document representation.

Even with advancements, searching, navigating, and presenting the morass of information is oft times still a frustrating user experience.

### BRIEF DESCRIPTION OF THE DRAWINGS

FIG. 1A is a screen display of example gesture based input performed by an example Gesture Based Content Presentation System (GBCPS) or process.

FIG. 1B is a screen display of a presentation of example gesture based auxiliary content determined by an example Gesture Based Content Presentation System or process.

FIG. 1C is a screen display of an animated overlay presentation as shown over time of example gesture based auxiliary content determined by an example Gesture Based Content Presentation System or process.

FIG. 1D is a screen display of artifacts of an overlay presentation of example gesture based auxiliary content determined by an example Gesture Based Content Presentation System or process.

FIGS. 1E1-1E9 are example screen displays of a sliding pane overlay sequence as shown over time for presenting auxiliary content by an example Gesture Based Content Presentation System.

FIG. 1F is a screen display of other example gesture based auxiliary content determined by an example Gesture Based Content Presentation System or process.

FIG. 1G is a screen display of other example of example gesture based auxiliary content determined by an example Gesture Based Content Presentation System or process.

FIG. 1H is a block diagram of an example environment for presenting auxiliary content using an example Gesture Based Content Presentation System or process.

FIG. 2 is an example block diagram of components of an example Gesture Based Content Presentation System.

FIG. 3.1-3.91 are example flow diagrams of example logic for processes for presenting auxiliary content based upon gestured input as performed by example embodiments.

FIG. 4 is an example block diagram of a computing system for practicing embodiments of a Gesture Based Content Presentation System.

### DETAILED DESCRIPTION

Embodiments described herein provide enhanced computer- and network-based methods, techniques, and systems for automatically presenting auxiliary content in a gesture based input system. Example embodiments provide a Gesture Based Content Presentation System (GBCPS), which enables a gesture-based user interface to determine (e.g., find, locate, generate, designate, define or cause to be found, located, generated, designated, defined, or the like) auxiliary content related to an portion of electronic input that has been indicated by a received gesture and to present (e.g., display, play sound for, draw, and the like) such content.

In overview, the GBCPS allows a portion (e.g., an area, part, or the like) of electronically presented content to be dynamically indicated by a gesture. The gesture may be provided in the form of some type of pointer, for example, a mouse, a touch sensitive display, a wireless device, a human body part, a microphone, a stylus, and/or a pointer that indicates a word, phrase, icon, image, or video, or may be provided in audio form. The GBCPS then examines the indicated portion in conjunction with a set of (e.g., one or more) factors to determine some auxiliary content that is, typically, related to the indicated portion and/or the factors. The GBCPS then automatically presents the auxiliary content on a presentation device (e.g., a display, a speaker, or other output device). For example, if the GBCPS determines that an advertisement is an appropriate auxiliary content corresponding to an indicated (e.g., gestured) portion, then the advertisement may be presented to the user (textually, visually, and/or via audio) instead of or in conjunction with the already presented content.

The determination of the auxiliary content is based upon content contained in the portion of the presented electronic indicated by the gestured input as well as possibly one or more of a set of factors. Content may include, for example, a word, phrase, spoken utterance, image, video, pattern, and/or other audio signal. Also, the portion may be formed from contiguous or composed of separate non-contiguous parts, for example, a title with a disconnected sentence. In addition, the indicated portion may represent the entire body of electronic content presented to the user. For the purposes described herein, the electronic content may comprise any type of content that can be presented for gestured input, including, for example, text, a document, music, a video, an image, a sound, or the like.

As stated, the GBCPS may incorporate information from a set of factors (e.g., criteria, state, influencers, things, features, and the like) in addition to the content contained in the indicated portion. The set of factors that may influence what auxiliary content is determined to be appropriate may include such things as context surrounding or otherwise relating to the indicated portion (as indicated by the gesture), such as other text, audio, graphics, and/or objects within the presented electronic content; some attribute of the gesture itself, such as size, direction, color, how the gesture is steered (e.g., smudged, nudged, adjusted, and the like); presentation device capabilities, for example, the size of the presentation device, whether text or audio is being presented; prior device communication history, such as what other devices have recently been used by this user or to which other devices the user has been connected; time of day; and/or prior history associated with the user, such as prior search history, navigation history, purchase history, and/or demographic information (e.g., age, gender, location, contact information, or the like). In addition, information from a context menu, such as a selection of a menu item by the user, may be used to assist the GBCPS in determining auxiliary content.

Once the auxiliary content is determined, the GBCPS automatically presents the determined auxiliary content. Presenting the auxiliary content may also involve “navigating” to the content, such as by changing the user's focus to new content. The auxiliary content is “auxiliary” content in that it is additional, supplemental or somehow related to what is currently presented to the user as the presented electronic content. The auxiliary content may be anything, including, for example, a web page, computer code, electronic document, electronic version of a paper document, a purchase or an offer to purchase a product or service, social networking content, and/or the like.

This auxiliary content is the presented to the user in conjunction with the presented electronic content, for example, by use of an overlay; in a separate presentation element (e.g., window, pane, frame, or other construct) such as a window juxtaposed to (e.g., next to, contiguous with, nearly up against) the presented electronic content; and/or, as an animation, for example, a pane that slides in to partially or totally obscure the presented electronic content. With animated presentations, artifacts of the movement may be also presented on the screen. In some examples, separate presentation constructs (e.g., windows, panes, frames, etc.) are used, each for some purpose, e.g., one presentation construct for the presented electronic content containing the indicated portion, another presentation construct for advertising, and another presentation construct for related auxiliary content. In some examples, a user may opt in or out of receiving the advertising and fewer presentation constructs may be presented. Other methods of presenting the auxiliary content and layouts are contemplated.

### Gesture Based Content Presentation System Overview

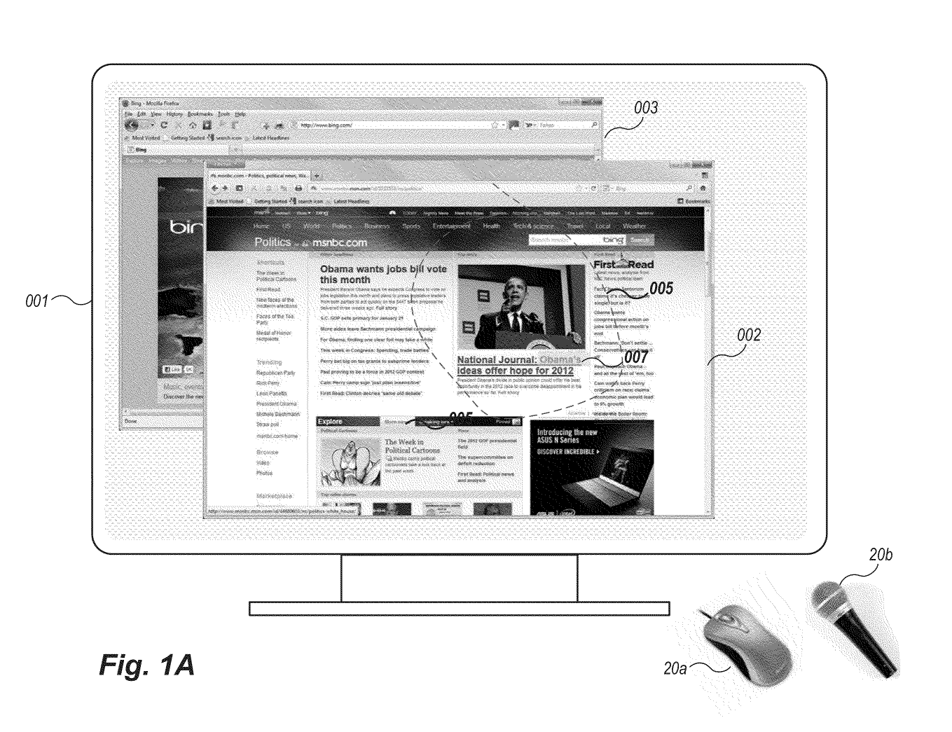

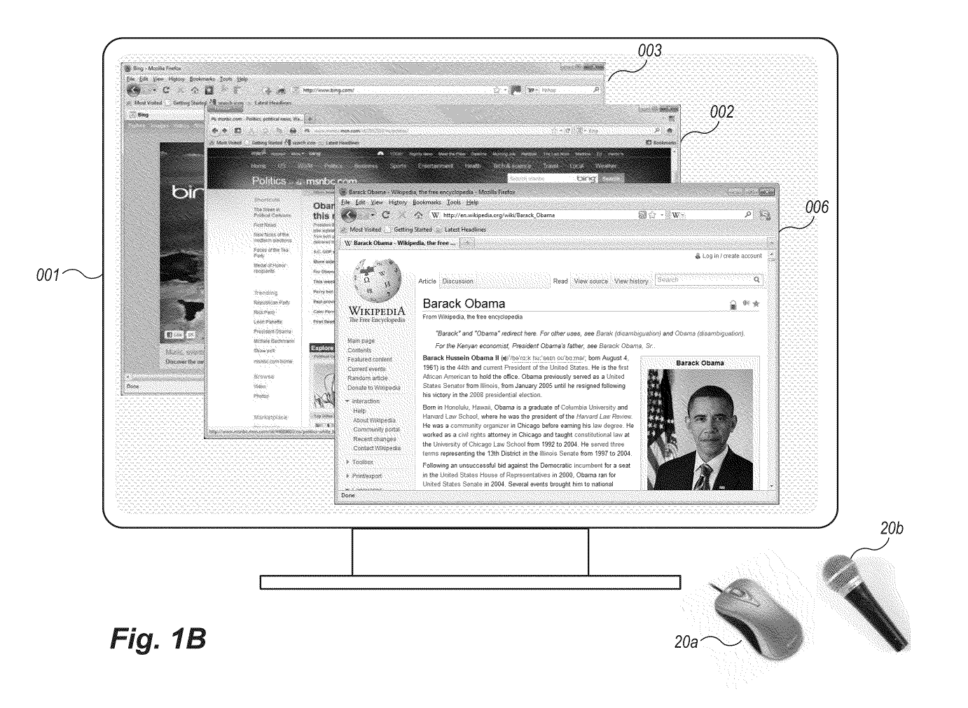

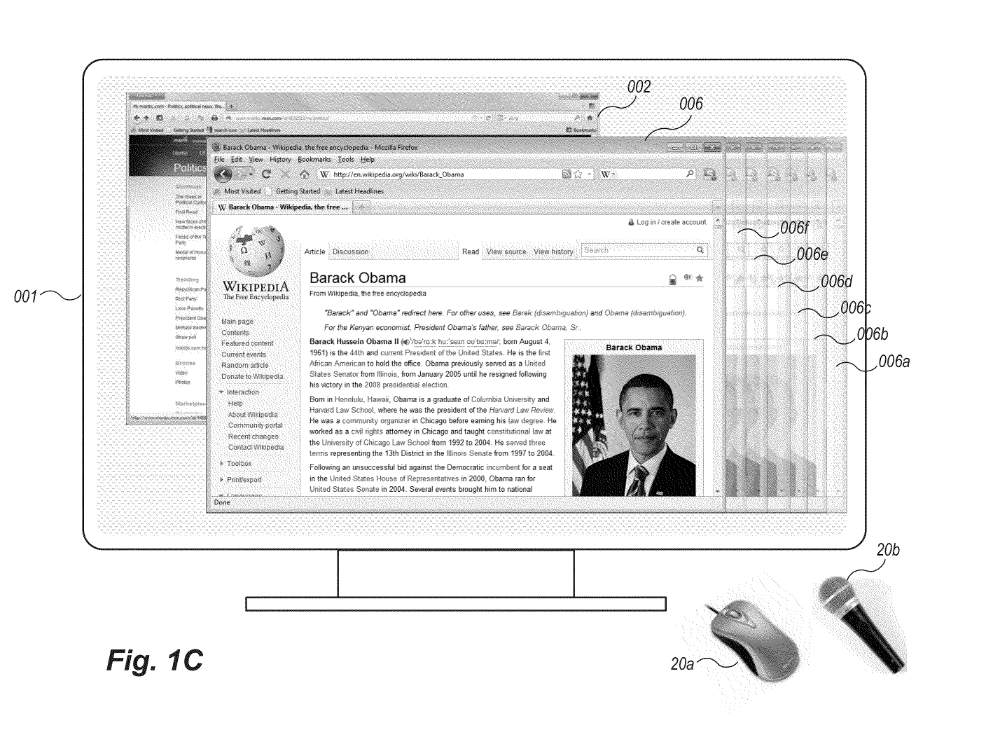

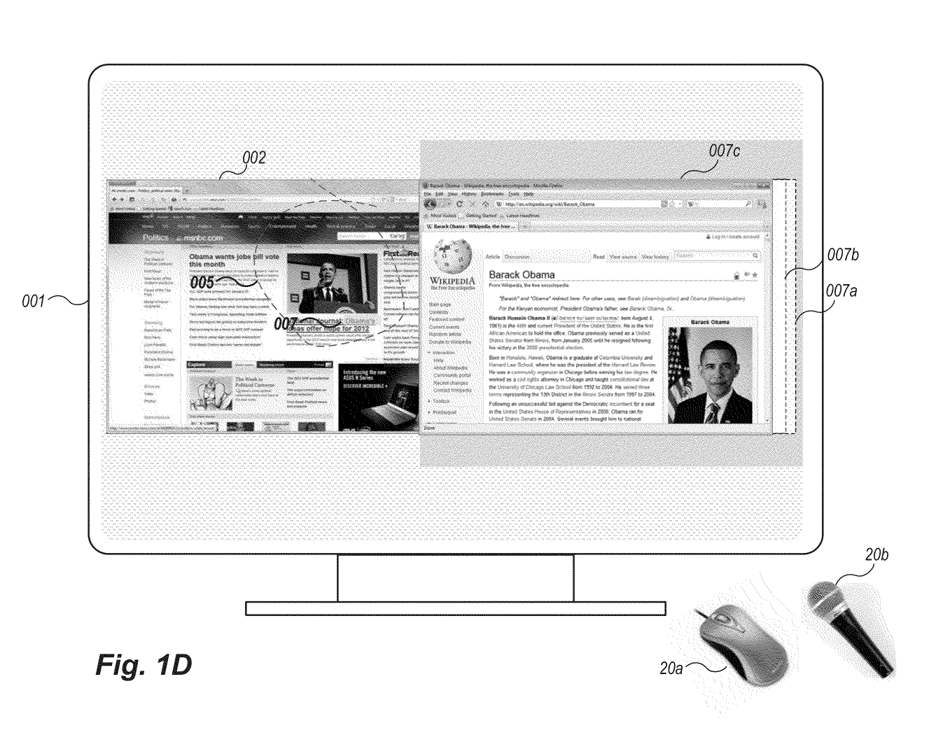

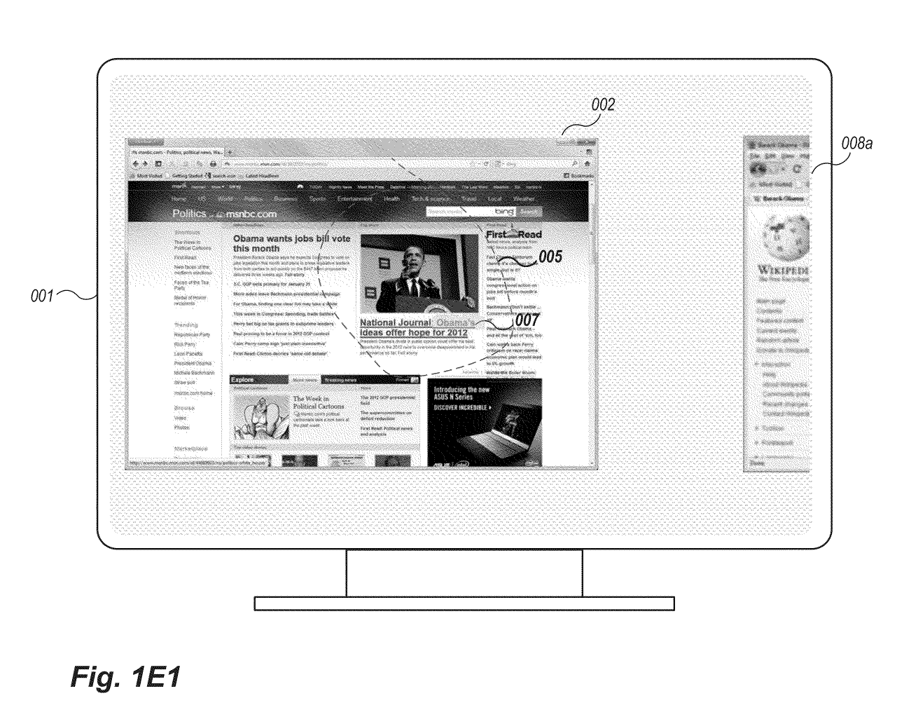

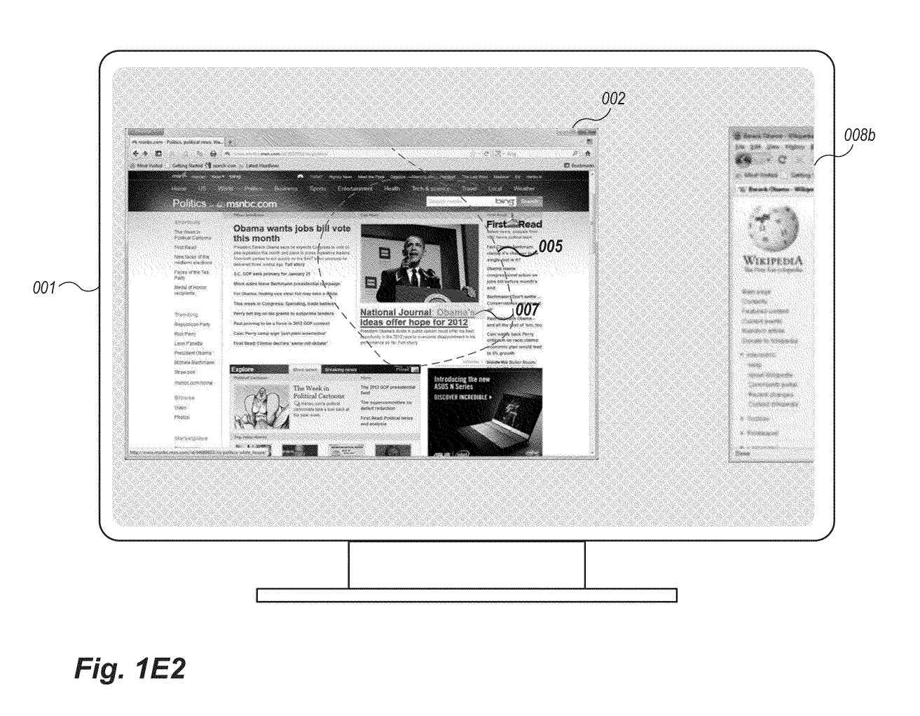

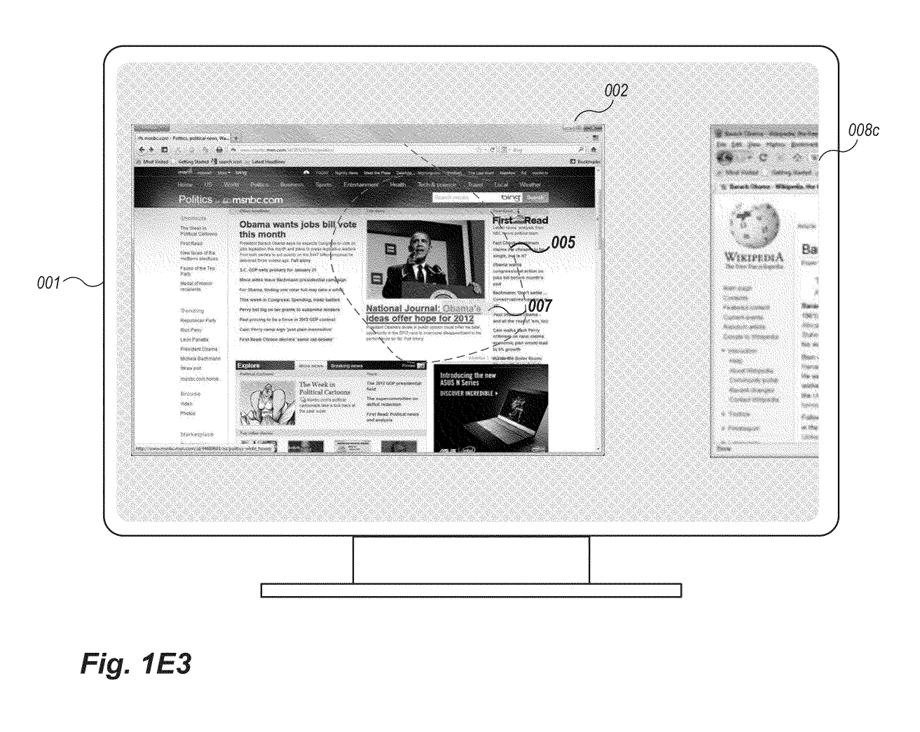

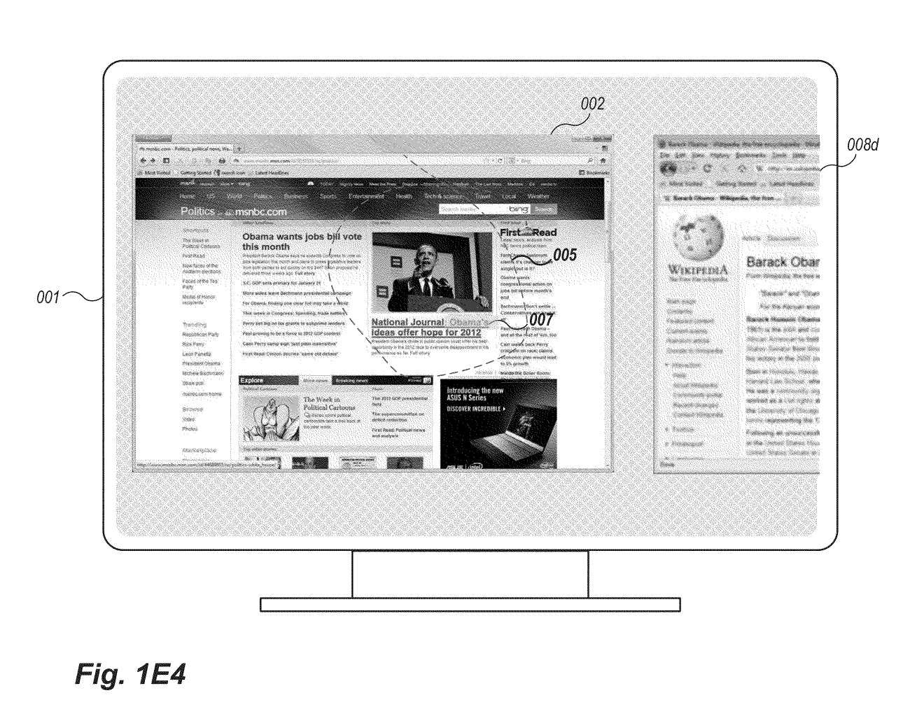

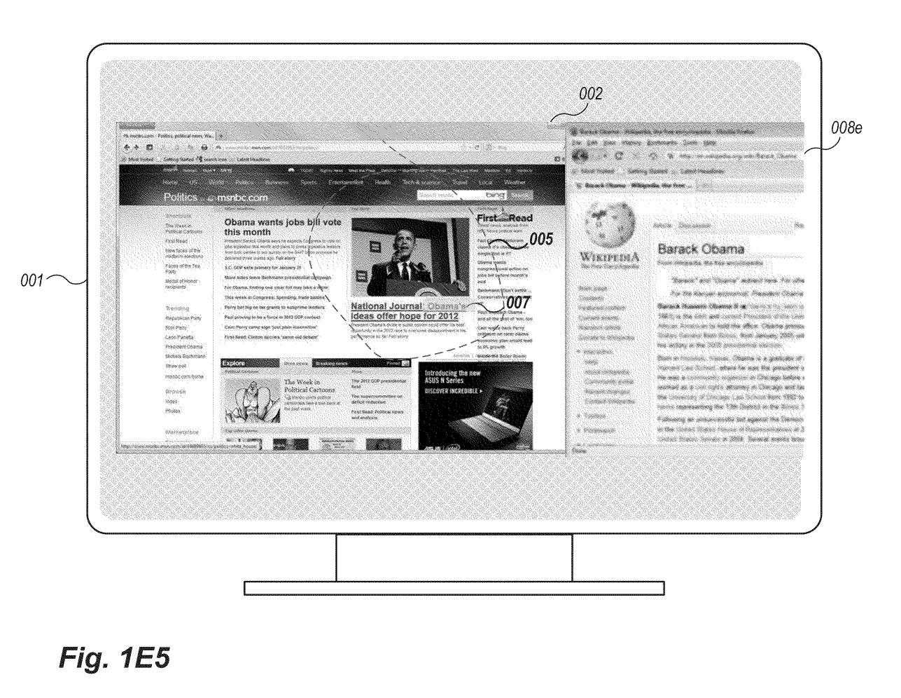

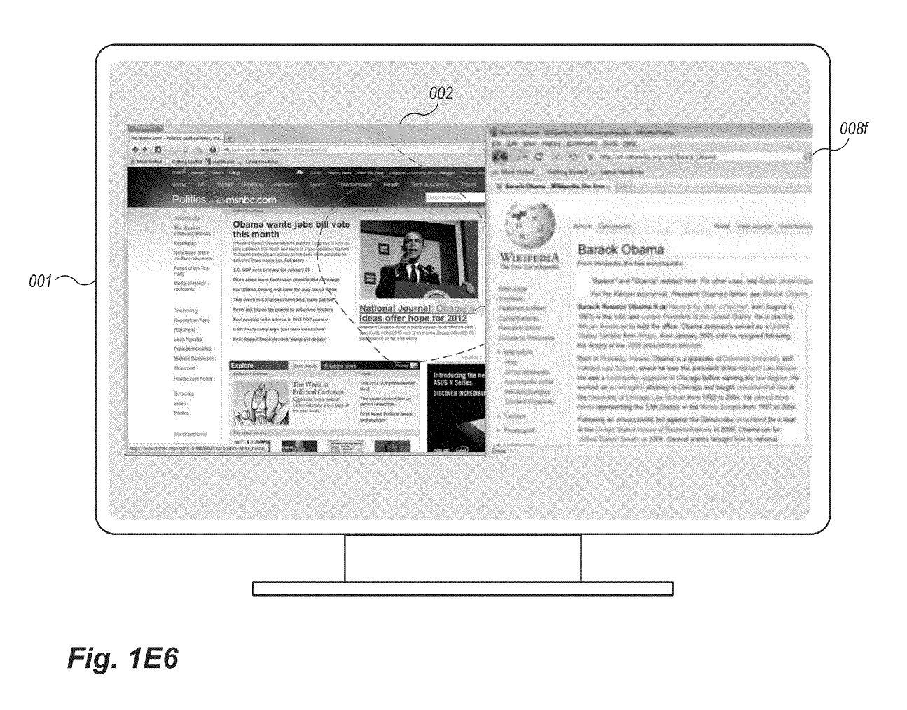

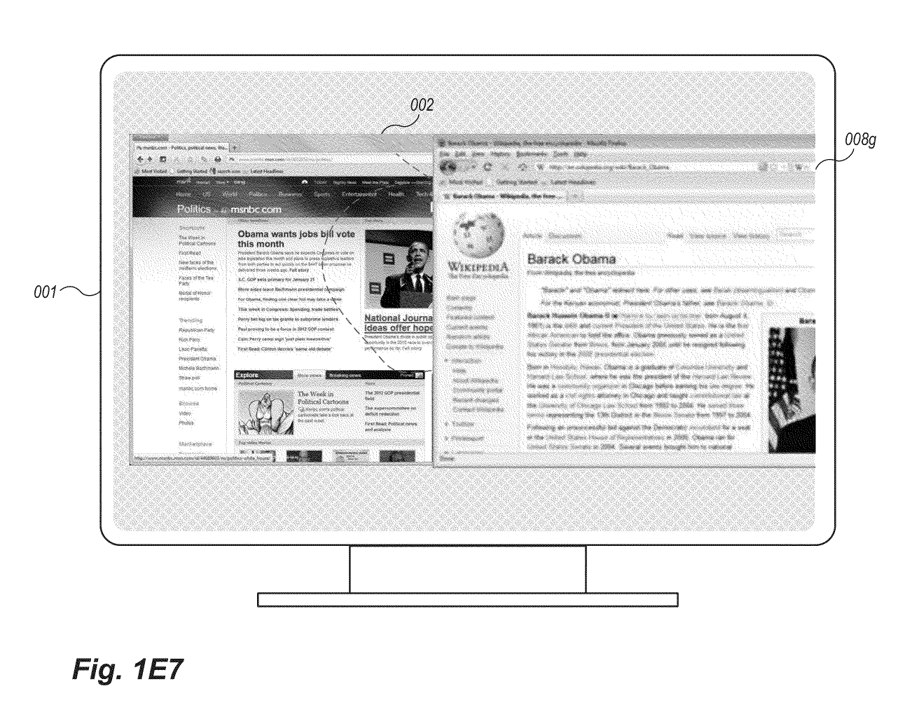

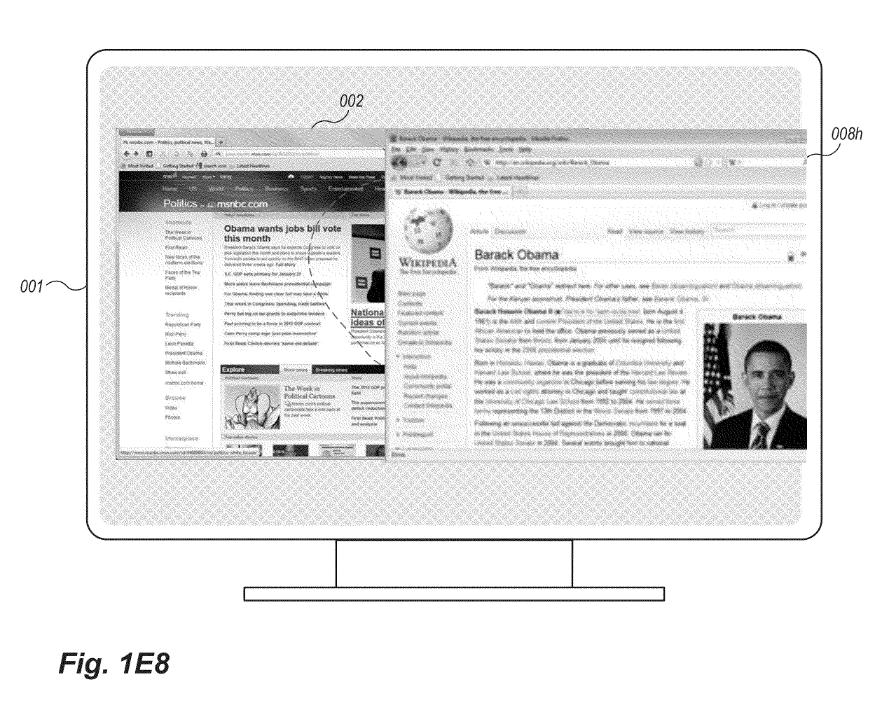

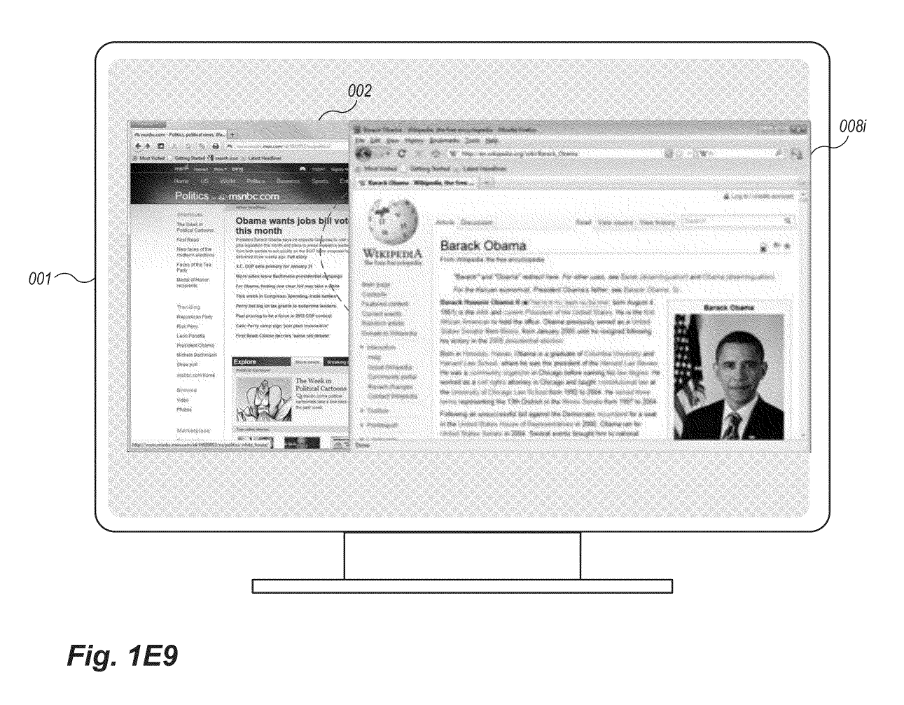

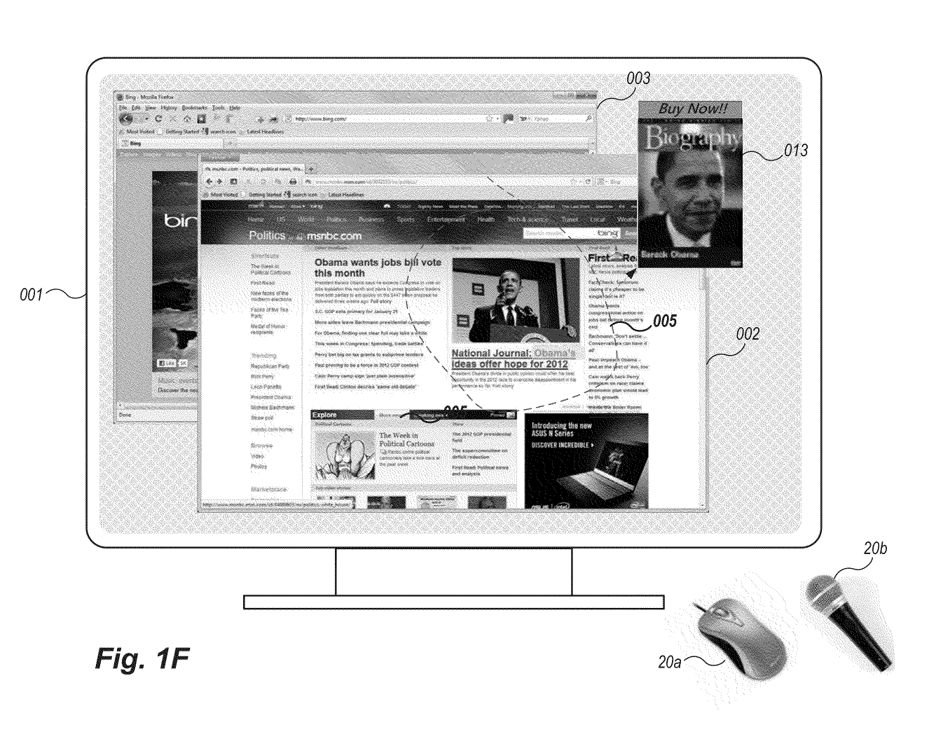

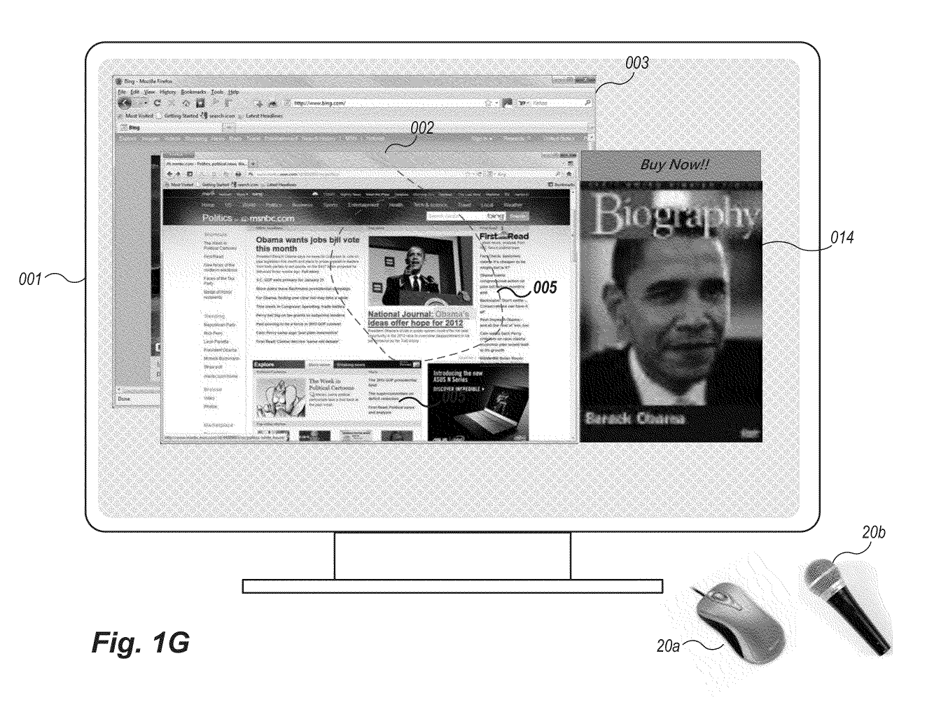

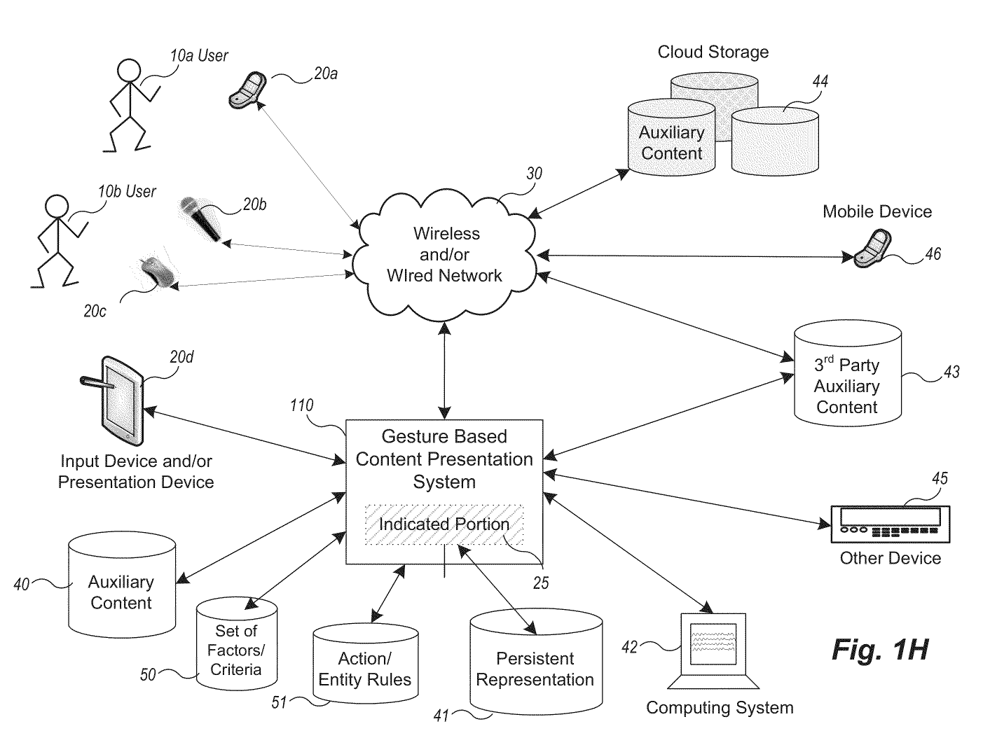

FIG. 1A is a screen display of example gesture based input performed by an example Gesture Based Content Presentation System (GBCPS) or process. In FIG. 1A, a presentation device, such as computer display screen 001, is shown presenting two windows with electronic content, window 002 and window 003. The user (not shown) utilizes an input device, such as mouse 20a and/or a microphone 20b, to indicate a gesture (e.g., gesture 005) to the GBCPS. The GBCPS, as will be described in detail elsewhere herein, determines to which portion of the electronic content displayed in window 002 the gesture 005 corresponds, potentially including what type of gesture. In the example illustrated, gesture 005 was created using the mouse device 20a and represents a closed path (shown in red) that is not quite a circle or oval that indicates that the user is interested in the entity “Obama.” The gesture may be a circle, oval, closed path, polygon, or essentially any other shape recognizable by the GBCPS. The gesture may indicate content that is contiguous or non-contiguous. Audio may also be used to indicate some area of the presented content, such as by using a spoken word, phrase, and/or direction (e.g., command, order, directional command, or the like). Other embodiments provide additional ways to indicate input by means of a gesture. The GBCPS can be fitted to incorporate any technique for providing a gesture that indicates some area or portion (including any or all) of presented content. The GBCPS has highlighted the text 007 to which gesture 005 is determined to correspond.

In the example illustrated, the GBCPS determines from the indicated portion (the text “Obama”) and one or more factors, such as the user's prior navigation history, that the user may be interested in more detailed information regarding the indicated portion. In this case, the user has been known to employ “Wikipedia” for obtaining detailed information about entities. Thus, the GBCPS navigates to and presents additional content on the entity Obama available from Wikipedia (after, for example, performing a search using a search engine locally or remotely coupled to the system). In this case, any search engine could be employed, such as a keyword search engine like Bing, Google, Yahoo, or the like.

FIG. 1B is a screen display of an example gesture based auxiliary content determined by an example Gesture Based Content Presentation System or process. In this example, the auxiliary content is the web page 006 resulting from a search for the entity “Obama” from Wikipedia. This content is shown as an overlay over at least one of the windows 002 on the presentation device 001 that contains the presented electronic content upon which the gesture was indicated. The user could continue navigating from here to other auxiliary content using gestures to find more detailed information on Obama, for example, by indicating by a gesture an additional entity or action that the user desires information on.

For the purposes of this description, an “entity” is any person, place, or thing, or a representative of the same, such as by an icon, image, video, utterance, etc. An “action” is something that can be performed, for example, as represented by a verb, an icon, an utterance, or the like.

The additional content on web page 006 may be presented in ways other than as a single overlay over window 002. For example, FIG. 1C is a screen display of an animated overlay presentation as shown over time of example gesture based auxiliary content determined by an example Gesture Based Content Presentation System or process. In FIG. 1C, the same web page 006 is shown coming into view as an overlay using animation techniques. According to this presentation, the windows 006a-006f are intended to show the window 006 as would be presented in prior moments in time as the window 006 is brought into focus from the side of presentation screen 001. For example, the window in position 006a moves to the position 006b, then 006c, and the like, until the window reaches its desired position as shown as window 006. In the example shown, a shadow of the window continues to be displayed as an artifact on the screen at each position 006a-006f, however this is not necessary. The artifacts may be helpful to the user in perceiving the animation.

FIG. 1D is a screen display of artifacts of an overlay presentation of example gesture based auxiliary content determined by an example Gesture Based Content Presentation System or process. It illustrates a different example overlay presentation where the window movement is animated differently. In this scenario, the window containing the auxiliary content is moved into position in a way that preserves visibility of a greater portion of the presented electronic content in window 002. The windows 007a-007c are intended to show the window with auxiliary content at different sequential points in time as it comes into view as an overlay (window “moves” from position 007a to position 007c). Artifacts may or may not be presented.

FIGS. 1E1-1E9 are example screen displays of a sliding pane overlay sequence as shown over time for presenting auxiliary content by an example Gesture Based Content Presentation System. They illustrate an animation of presenting auxiliary content over time as sliding in from the side of the presentation screen 001 (here from the right hand side) until the window with the auxiliary content reaches its destination (as window 008i) as an overlay on the presented electronic content in window 002. As time progresses from earliest to latest, as shown from FIG. 1E1 in sequence to 1E9, the window 008x (where x is a-i) moves closer and closer onto presented content where the gesture was made. Eventually, the auxiliary content in window 008f-008i is shown covering up more and more of the gestured portion. In other examples, when the pane slides in from the side of the screen the portion of the electronic content in window 002 indicating the gestured portion (as shown by gesture 005) always remains visible. Sometimes this is accomplished by not moving in the auxiliary content as far. In other instances, the window 002 is readjusted (e.g., scrolled, the content repositioned, etc.) to maintain both display of the gestured portion and the auxiliary content. Other animations and non-animations of presenting auxiliary content using overlays and/or additional presentation constructs are possible.

Suppose, on the other hand, the GBCPS determined from the scenario described with reference to FIG. 1A that the user tended to like to use the computer for purchases (instead of, or in addition to, Wikipedia). In this case, the GBCPS may surmise this (as one of the factors for choosing auxiliary content) by looking at the user's prior navigation history, purchase history, or the like. In this case, the GBCPS determines that an opportunity for commercialization, such as an advertisement, should be a target (e.g., the next presented) auxiliary content.

FIG. 1F is a screen display of other example gesture based auxiliary content determined by an example Gesture Based Content Presentation System or process. In this example, an advertisement for a book on the entity “Obama” (the gestured indicated portion) is presented as presentation overlay 013 accompanying the gestured input 005 on window 002. The user could next use the gestural input system to select the advertisement on the book on “Obama” to create a purchase opportunity.

FIG. 1G is screen display of other example gesture based auxiliary content determined by an example Gesture Based Content Presentation System or process. In this example, the same advertisement for a book on the entity “Obama” (the gestured indicated portion) is presented as presentation 014 alongside the gestured input 005 on window 002. The user could next use the gestural input system to select the advertisement on the book on “Obama” to create a purchase opportunity.

As illustrated in FIG. 1F, the advertisement is shown as an overlay over both windows 002 and 003 on the presentation device 001. In other examples, the auxiliary content may be displayed in a separate pane, window, frame, or other construct as illustrated in FIG. 1G. In some other examples, the auxiliary content is brought into view in an animated fashion from one side of the screen and partially overlaid on top of the presented electronic content that the user is viewing such as shown in FIG. 1C or 1D. For example, the auxiliary content may appear to “move into place” from one side of a presentation device as shown in FIGS. 1E1-1E9. In other examples, the auxiliary content may be placed in another window, pane, frame, or the like, which may or may not be juxtaposed, overlaid, or just placed in conjunction with to the initial presented content. Other arrangements are of course contemplated.

In some embodiments, the GBCPS may interact with one or more remote and/or third party systems to determine and to present auxiliary content. For example, to achieve the presentation illustrated in FIGS. 1F and 1G, the GBCPS may invoke a third party advertising supplier system to cause it to serve (e.g., deliver, forward, send, communicate, etc.) an appropriate advertisement oriented to other factors related to the user, such as gender, age, location, etc.

FIG. 1H is a block diagram of an example environment for determining and presenting auxiliary content using an example Gesture Based Content Presentation System (GBCPS) or process. One or more users 10a, 10b, etc. communicate to the GBCPS 110 through one or more networks, for example, wireless and/or wired network 30, by indicating gestures using one or more input devices, for example a mobile device 20a, an audio device such as a microphone 20b, or a pointer device such as mouse 20c or the stylus on table device 20d (or for example, or any other input device, such as a keyboard of a computer device or a human body part, not shown). For the purposes of this description, the nomenclature “*” indicates a wildcard (substitutable letter(s)). Thus, user 20* may indicate a device 20a or a device 20b. The one or more networks 30 may be any type of communications link, including for example, a local area network or a wide area network such as the Internet.

Auxiliary content may be determined and presented as a user indicates, by means of a gesture, different portions of the presented content. Many different mechanisms for causing auxiliary content to be presented can be accommodated, for example, a “single-click” of a mouse button following the gesture, a command via an audio input device such as microphone 20b, a secondary gesture, etc. Or in some cases, the determination and presentation is initiated automatically as a direct result of the gesture—without additional input—for example, as soon as the GBCPS determines the gesture is complete.

For example, once the user has provided gestured input, the GBCPS 110 will determine to what portion the gesture corresponds. In some embodiments, the GBCPS 110 may take into account other factors in addition to the indicated portion of the presented content. The GBCPS 110 determines the indicated portion 25 to which the gesture-based input corresponds, and then, based upon the indicated portion 25, and possibly a set of factors 50, (and, in the case of a context menu, based upon a set of action/entity rules 51) determines auxiliary content. Then, once the auxiliary content is determined (e.g., indicated, linked to, referred to, obtained, or the like) the GBCPS 110 presents the auxiliary content.

The set of factors (e.g., criteria) 50 may be dynamically determined, predetermined, local to the GBCPS 110, or stored or supplied externally from the GBCPS 110 as described elsewhere. This set of factors may include a variety of aspects, including, for example: context of the indicated portion of the presented content, such as other words, symbols, and/or graphics nearby the indicated portion, the location of the indicated portion in the presented content, syntactic and semantic considerations, etc.; attributes of the user, for example, prior search, purchase, and/or navigation history, demographic information, and the like; attributes of the gesture, for example, direction, size, shape, color, steering, and the like; and other criteria, whether currently defined or defined in the future. In this manner, the GBCPS 110 allows presentation of auxiliary content to become “personalized” to the user as much as the system is tuned.

As explained with reference to FIGS. 1A-1G, (an indication to) the auxiliary content is determined by inference—based upon the content encompassed by the gesture and a set of factors. This contrasts to explicit navigation where the user directs the system what next content to present. In some embodiments, the GBCPS may incorporate a mixture of user direction (e.g., from a context menu or the like) and inference to determine an indication of auxiliary content to present. The auxiliary content may be stored local to the GBCPS 110, for example, in auxiliary content data repository 40 associated with a computing system running the GBCPS 110, or may be stored or available externally, for example, from another computing system 42, from third party content 43 (e.g., a 3^{rd} party advertising system, external content, a social network, etc.) from auxiliary content stored using cloud storage 44, from another device 45 (such as from a settop box, NV component, etc.), from a mobile device connected directly or indirectly with the user (e.g., from a device associated with a social network associated with the user, etc.), and/or from other devices or systems not illustrated. Third party content 43 is demonstrated as being communicatively connected to both the GBCPS 110 directly and/or through the one or more networks 30. Although not shown, various of the devices and/or systems 42-46 also may be communicatively connected to the GBCPS 110 directly or indirectly. The auxiliary content may be any type of content and, for example, may include another document, an image, an audio snippet, an audio visual presentation, an advertisement, an opportunity for commercialization such as a bid, a product offer, a service offer, or a competition, and the like. Once the GBCPS 110 obtains the auxiliary content to present, the GBCPS 110 causes the auxiliary to be presented on a presentation device (e.g., presentation device 20d) associated with the user.

The GBCPS 110 illustrated in FIG. 1H may be executing (e.g., running, invoked, instantiated, or the like) on a client or on a server device or computing system. For example, a client application (e.g., a web application, web browser, other application, etc.) may be executing on one of the presentation devices, such as tablet 20d. In some embodiments, some portion or all of the GBCPS 110 components may be executing as part of the client application (for example, downloaded as a plug-in, active-x component, run as a script or as part of a monolithic application, etc.). In other embodiments, some portion or all of the GBCPS 110 components may be executing as a server (e.g., server application, server computing system, software as a service, etc.) remotely from the client input and/or presentation devices 20a-d.

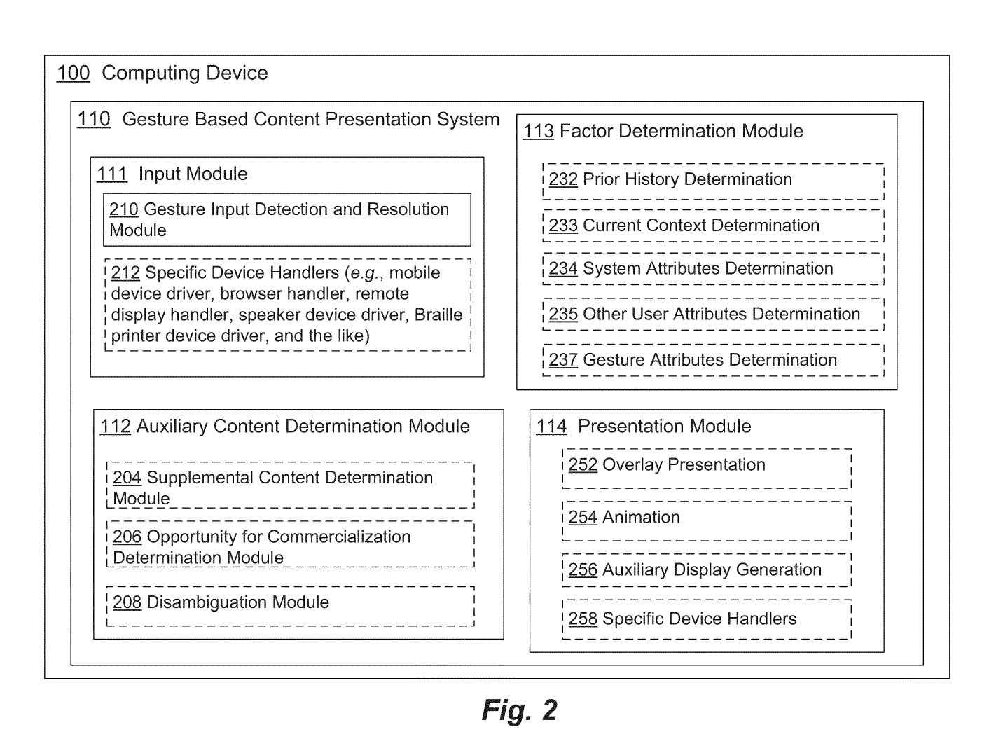

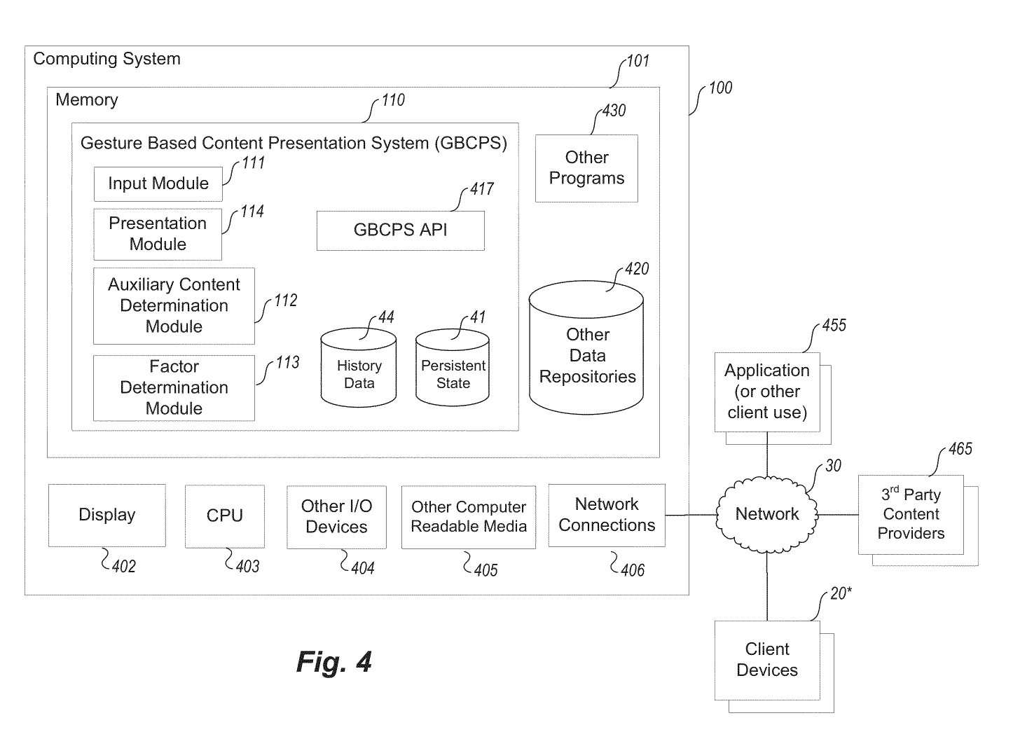

FIG. 2 is an example block diagram of components of an example Gesture Based Content Presentation System. In example GBCPSes such as GBCPS 110 of FIG. 1H, the GBCPS comprises one or more functional components/modules that work together to automatically present auxiliary content based upon gestured input. For example, a Gesture Based Content Presentation System 110 may reside in (e.g., execute thereupon, be stored in, operate with, etc.) a computing device 100 programmed with logic to effectuate the purposes of the GBCPS 110. As mentioned, a GBCPS 110 may be executed client side or server side. For ease of description, the GBCPS 110 is described as though it is operating as a server. It is to be understood that equivalent client side modules can be implemented. Moreover, such client side modules need not operate in a client-server environment, as the GBCPS 110 may be practiced in a standalone environment or even embedded into another apparatus. Moreover, the GBCPS 110 may be implemented in hardware, software, or firmware, or in some combination. In addition, although auxiliary content is typically presented on a client presentation device such as devices 20*, the content may be implemented server-side or some combination of both. Details of the computing device/system 100 are described below with reference to FIG. 4.

In an example system, a GBCPS 110 comprises an input module 111, an auxiliary content determination module 112, a factor determination module 113, and a presentation module 114. In some embodiments the GBCPS 110 comprises additional and/or different modules as described further below.

Input module 111 is configured and responsible for determining the gesture and an indication of an area (e.g., a portion) of the presented electronic content indicated by the gesture. In some example systems, the input module 111 comprises a gesture input detection and resolution module 210 to aid in this process. The gesture input detection and resolution module 210 is responsible for determining, using different techniques, for example, pattern matching, parsing, heuristics, syntactic and semantic analysis, etc. to what area a gesture corresponds and what word, phrase, image, audio clip, etc. is indicated. In some example systems, the input module 111 is configured to include specific device handlers 212 (e.g., drivers) for detecting and controlling input from the various types of input devices, for example devices 20*. For example, specific device handlers 212 may include a mobile device driver, a browser “device” driver, a remote display “device” driver, a speaker device driver, a Braille printer device driver, and the like. The input module 111 may be configured to work with and or dynamically add other and/or different device handlers.

The gesture input detection and resolution module 210 may be further configured to include a variety of modules and logic (not shown) for handling a variety of input devices and systems. For example, gesture input detection and resolution module 210 may be configured to handle gesture input by way of audio devices and/or a to handle the association of gestures to graphics in content (such as an icon, image, movie, still, sequence of frames, etc.). In addition, in some example systems, the input module 111 may be configured to include natural language processing to detect whether a gesture is meant to indicate a word, a phrase, a sentence, a paragraph, or some other portion of presented electronic content using techniques such as syntactic and/or semantic analysis of the content. In some example systems, the input module 111 may be configured to include gesture identification and attribute processing for handling other aspects of gesture determination such as determining the particular type of gesture (e.g., a circle, oval, polygon, closed path, check mark, box, or the like) or whether a particular gesture is a “steering” gesture that is meant to correct, for example, an initial path indicated by a gesture; a “smudge” which may have its own interpretation such as extend the gesture “here;” the color of the gesture, for example, if the input device supports the equivalent of a colored “pen” (e.g., pens that allow a user can select blue, black, red, or green); the size of a gesture (e.g., whether the gesture draws a thick or thin line, whether the gesture is a small or large circle, and the like); the direction of the gesture (up, down, across, etc.); and/or other attributes of a gesture.

Other modules and logic may be also configured to be used with the input module 111.

Auxiliary content determination module 112 is configured and responsible for determining the auxiliary content to be presented. As explained, this determination may be based upon the context—the portion indicated by the gesture and potentially a set of factors (e.g., criteria, properties, aspects, or the like) that help to define context. The auxiliary content determination module 112 may invoke the factor determination module 113 to determine the one or more factors to use to assist in determining the auxiliary content by inference. The factor determination module 113 may comprise a variety of implementations corresponding to different types of factors, for example, modules for determining prior history associated with the user, current context, gesture attributes, system attributes, or the like.

In some cases, for example, when the portion of content indicated by the gesture is ambiguous or not clear by the indicated portion itself, the auxiliary content determination module 112 may utilize a disambiguation module 208 to help disambiguate the indicated portion of content. For example, if a gesture has indicated the word “Bill,” the disambiguation module 208 may help distinguish whether the user is likely interested in a person whose name is Bill or a legislative proposal. In addition, based upon the indicated portion of content and the set of factors, more than one auxiliary content may be identified. If this is the case, then the auxiliary content determination module 112 may use the disambiguation module 208 and other logic to select an auxiliary content to present. The disambiguation module 208 may utilize syntactic and/or semantic aids, user selection, default values, and the like to assist in the determination of auxiliary content.

In some example systems, the auxiliary content determination module 112 is configured to determine (e.g., find, establish, select, realize, resolve, establish, etc.) auxiliary or supplemental content that best matches the gestured input and/or a set of factors. Best match may include content that is, for example, most related syntactically or semantically, closest in “proximity” however proximity is defined (e.g., content that relates to a relative of the user or the user's social network), most often presented given the entity(ies) encompassed by the gesture, and the like. Other definitions for determined what auxiliary content best relates to the gestured input and/or one or more of the set of factors is contemplated and can be incorporated by the GBCPS.

The auxiliary content determination module 122 may be further configured to include a variety of different modules and/or logic to aid in this determination process. For example, the auxiliary content determination module 122 may be configured to include an opportunity for commercialization determination 206 to determine one or more types of commercial opportunities (e.g., bidding opportunities, computer-assisted competitions, advertisements, games, purchase and/or offers for products or services, interactive entertainment, or the like) that can be associated with the gestured input. For example, as shown in FIG. 1F, these advertisements may be provided by a variety of sources including from local storage, over a network (e.g., wide area network such as the Internet, a local area network, a proprietary network, an Intranet, or the like), from a known source provider, from third party content (available, for example from cloud storage or from the provider's repositories), and the like. In some systems, a third party advertisement provider system is used that is configured to accept queries for advertisements (“ads”) such as using keywords, to output appropriate advertising content.

The auxiliary content determination module 112 may be further configured to determine other types of supplemental content using a supplemental content determination module 204. The supplemental content determination module 204 may be configured to determine other content that somehow relates to (e.g., associated with, supplements, improves upon, corresponds to, has the opposite meaning from, etc.) the gestured input.

Other modules and logic may be also configured to be used with the auxiliary content determination module 122.

As mentioned, the auxiliary content determination module 112 may invoke the factor determination module 113 to determine the one or more factors to use to assist in determining the auxiliary content by inference. The factor determination module 113 may be configured to include a prior history determination module 232, a current context determination module 233, a system attributes determination module 234, other user attributes determination module 235, and/or a gesture attributes determination module 237. Other modules may be similarly incorporated.

In some example systems, the prior history determination module 232 is configured to determine (e.g., find, establish, select, realize, resolve, establish, etc.) prior histories associated with the user and is configured to include modules/logic to implement such. For example, the prior history determination module 232 may be configured to determine demographics (such as age, gender, residence location, citizenship, languages spoken, or the like) associated with the user. The prior history determination module 232 also may be configured determine a user's prior purchases. The purchase history may be available electronically, over the network, may be integrated from manual records, or some combination. In some systems, these purchases may be product and/or service purchases. The prior history determination module 232 may be configured to determine a user's prior searches. Such records may be stored locally with the GBCPS 110 or may be available over the network 30 or using a third party service, etc. The prior history determination module 232 also may be configured to determine how a user navigates through his or her computing system so that the GBCPS 110 can determine aspects such as navigation preferences, commonly visited content (for example, commonly visited websites or bookmarked items), etc.

In some example systems, the current context determination module 233 is configured to provide determinations of attributes regarding what the user is viewing, the underlying content, context relative to other containing content (if known), whether the gesture has selected a word or phrase that is located with certain areas of presented content (such as the title, abstract, a review, and so forth).

In some example systems, the system attributes determination module 234 is configured to determine aspects of the “system” that may provide influence or guidance (e.g., may inform) the determination of the portion of content indicated by the gestured input. These may include, for example, aspects of the GBCPS 110, aspects of the system that is executing the GBCPS 119 (e.g., the computing system 100), aspects of a system associated with the GBCPS 110 (e.g., a third party system), network statistics, and/or the like.

In some example systems, the other user attributes determination module 235 is configured to determine other attributes associated with the user not covered by the prior history determination module 232. For example, a user's social connectivity data may be determined by module 238.

In some example systems, the gesture attributes determination module 237 is configured to provide determinations of attributes of the gesture input, similar or different from those described relative to input module 111 for determining to what content a gesture corresponds. Thus, for example, the gesture attributes determination module 237 may provide information and statistics regarding size, length, shape, color, and/or direction of a gesture.

Other modules and logic may be also configured to be used with the factor determination module 113.

In some embodiments, the GBCPS uses context menus, for example, to allow a user to modify a gesture or to assist the GBCPS is inferring what auxiliary content is appropriate. In such a case, a context menu handling module (not shown) may be configured to process and handle menu presentation and input. It may be configured to include an items determination logic for determining what menu items to present on a particular menu, input handling logic for providing an event loop to detect and handle user selection of a menu item, viewing logic to determine what kind of “view” (as in a model/view/controller—MVC—model) to present (e.g., a pop-up, pull-down, dialog, interest wheel, and the like) and a presentation logic for determining when and what to present to the user and to determine an auxiliary content to present that is associated with a selection. In some embodiments, rules for actions and/or entities may be provided to determine what to present on a particular menu.

Once the auxiliary content is determined, the GBCPS 110 uses the presentation module 114 to present the auxiliary content. The GBCPS 110 forwards (e.g., communicates, sends, pushes, etc.) the auxiliary content to the presentation module 114 to cause the presentation module 114 to present the auxiliary content or cause another device to present it. The auxiliary content may be presented in a variety of manners, including via visual display, audio display, via a Braille printer, etc., and using different techniques, for example, overlays, animation, etc.

The presentation module 115 may be configured to include a variety of other modules and/or logic. For example, the presentation module 115 may be configured to include an overlay presentation module 252 for determining how to present auxiliary content in an overlay manner on a presentation device such as tablet 20d. Overlay presentation module 252 may utilize knowledge of the presentation devices to decide how to integrate the auxiliary content as an “overlay” (e.g., covering up a portion or all of the underlying presented content). For example, when the GBCPS 110 is run as a server application that serves web pages to a client side web browser, certain configurations using “html” commands or other tags may be used.

Presentation module 115 also may be configured to include an animation module 254. In some example systems, for example as described in FIGS. 1C-1E9, the auxiliary content may be “moved in” from one side or portion of a presentation device in an animated manner. For example, the auxiliary content may be placed in a pane (e.g., a window, frame, pane, etc., as appropriate to the underlying operating system or application running on the presentation device) that is moved in from one side of the display onto the content previously shown. Other animations can be similarly incorporated.

Presentation module 115 also may be configured to include an auxiliary display generation module 256 for generating a new graphic or audio construct to be presented in conjunction with the content already displayed on the presentation device. In some systems, the new content is presented in a new window, frame, pane, or other auxiliary display construct.

Presentation module 115 also may be configured to include specific device handlers 258, for example, device drivers configured to communicate with mobile devices, remote displays, speakers, Braille printers, and/or the like as described elsewhere. Other or different presentation device handlers may be similarly incorporated.

Also, other modules and logic may be also configured to be used with the presentation module 115.

Although the techniques of a Gesture Based Content Presentation System (GBCPS) are generally applicable to any type of gesture-based system, the phrase “gesture” is used generally to imply any type of physical pointing type of gesture or audio equivalent. In addition, although the examples described herein often refer to online electronic content such as available over a network such as the Internet, the techniques described herein can also be used by a local area network system or in a system without a network. In addition, the concepts and techniques described are applicable to other input and presentation devices. Essentially, the concepts and techniques described are applicable to any environment that supports some type of gesture-based input.

Also, although certain terms are used primarily herein, other terms could be used interchangeably to yield equivalent embodiments and examples. In addition, terms may have alternate spellings which may or may not be explicitly mentioned, and all such variations of terms are intended to be included.

Example embodiments described herein provide applications, tools, data structures and other support to implement a Gesture Based Content Presentation System (GBCPS) to be used for providing presentation of auxiliary content based upon gestured input. Other embodiments of the described techniques may be used for other purposes. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the logic or code flow, different logic, or the like. Thus, the scope of the techniques and/or components/modules described are not limited by the particular order, selection, or decomposition of logic described with reference to any particular routine.

### Example Processes

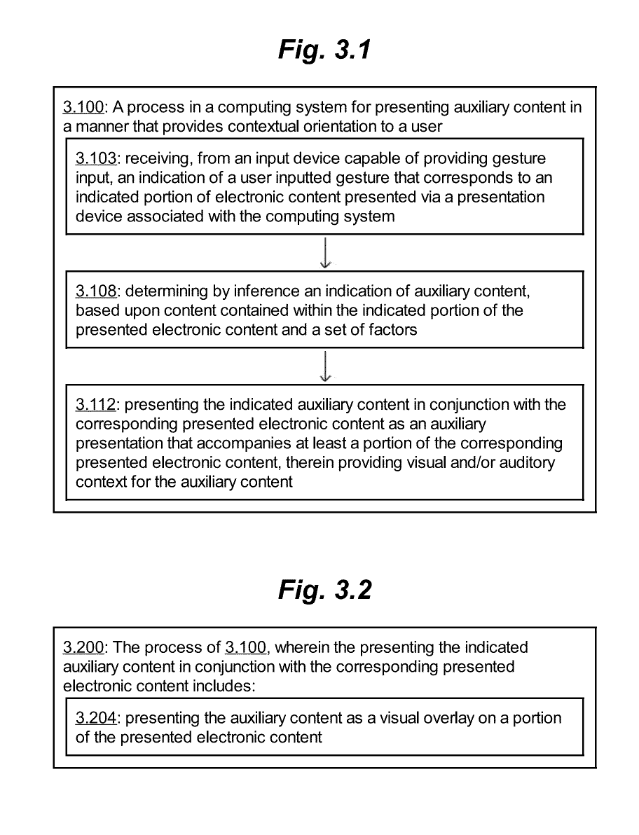

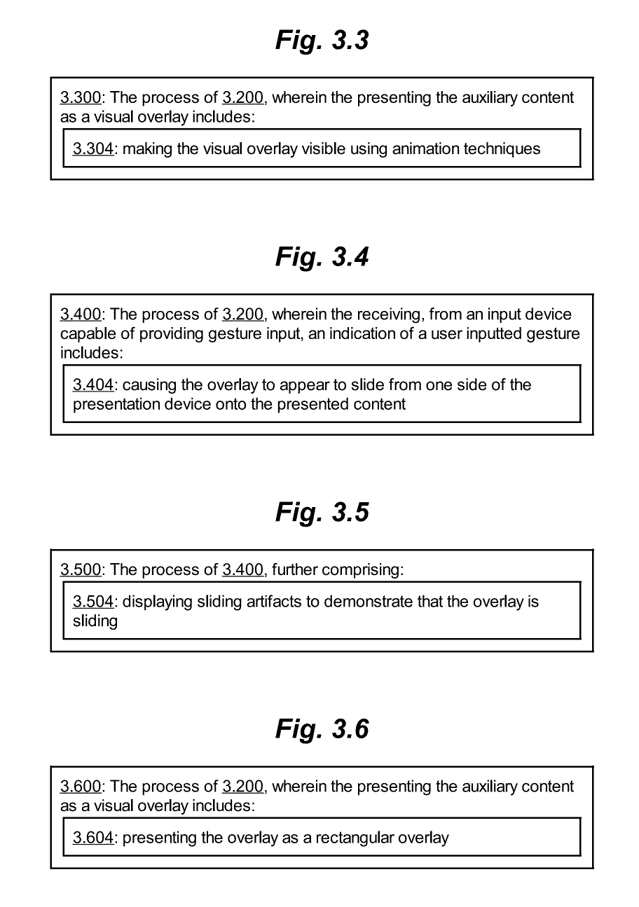

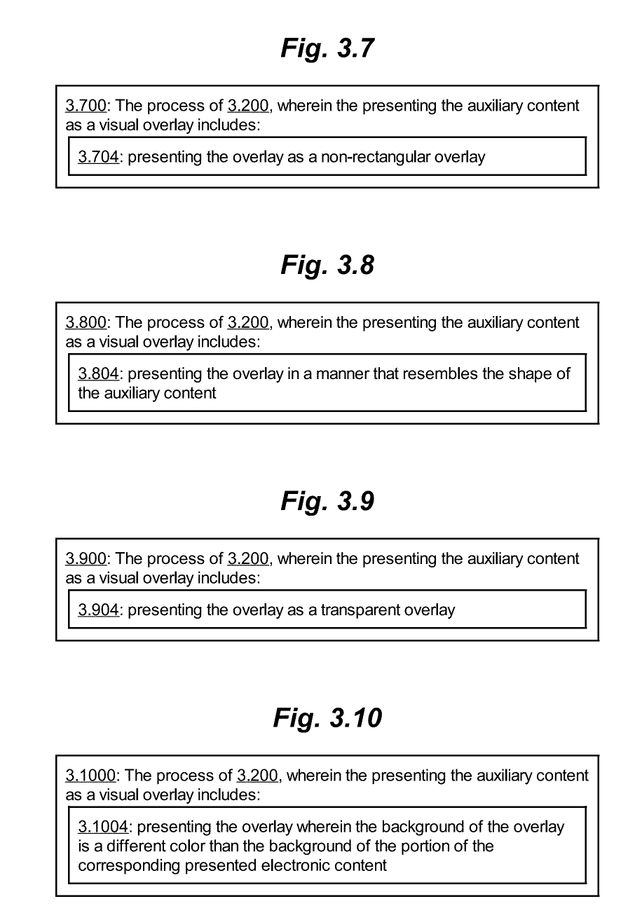

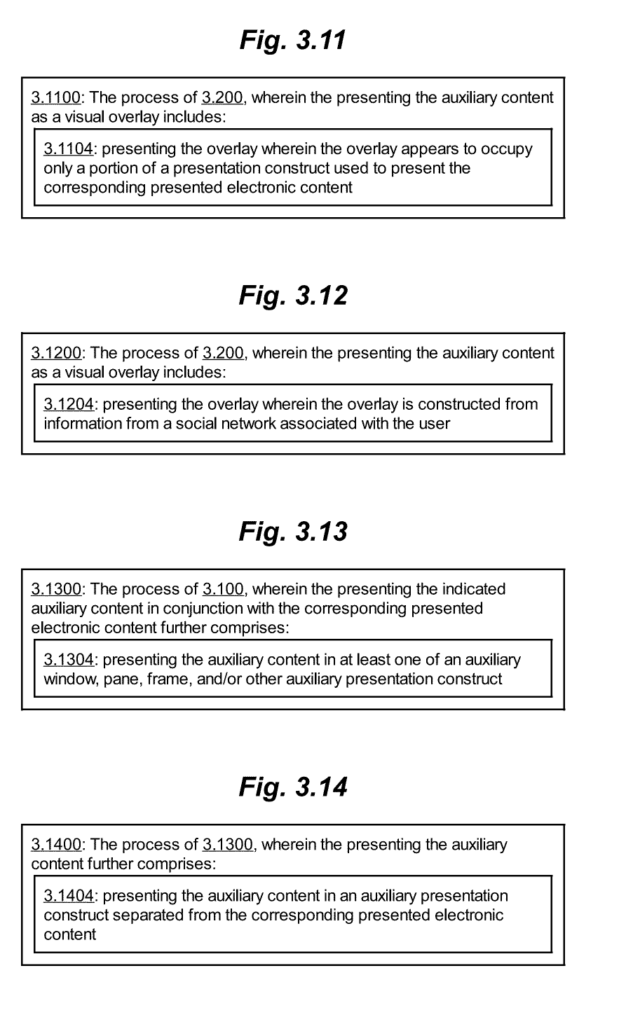

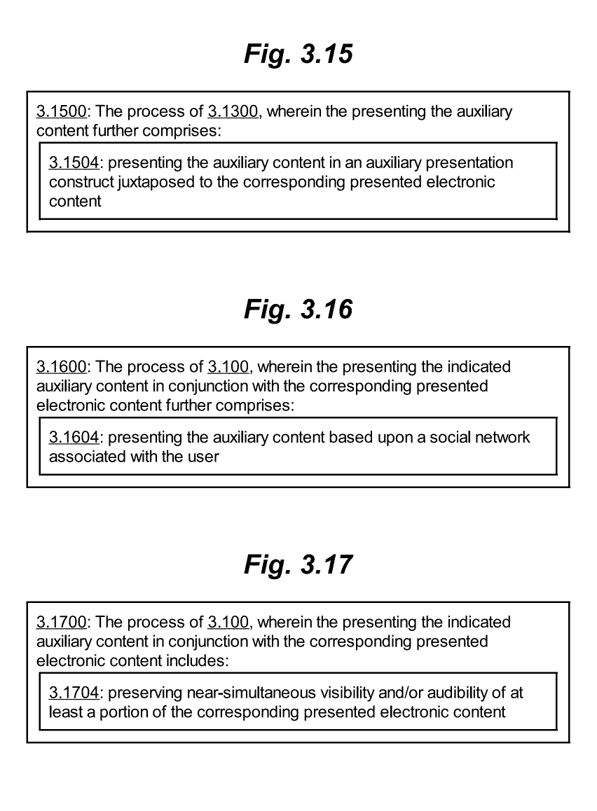

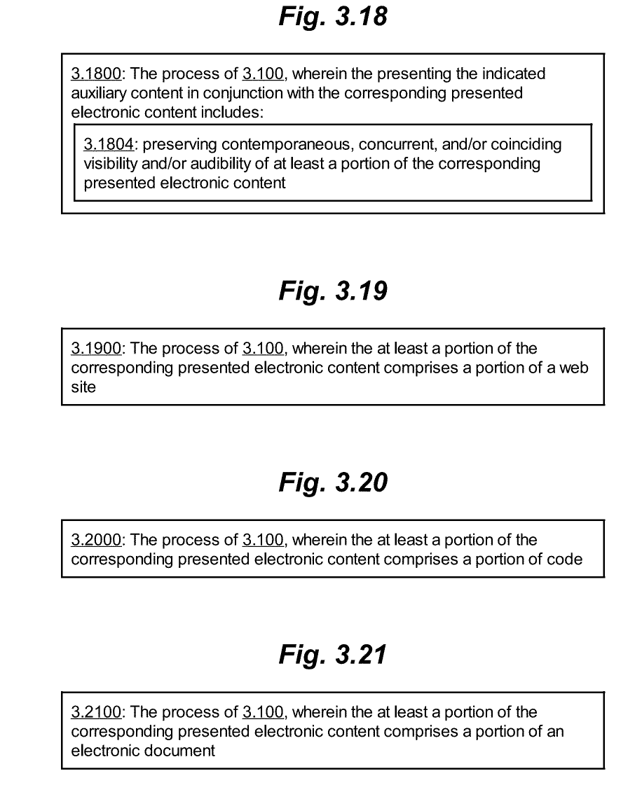

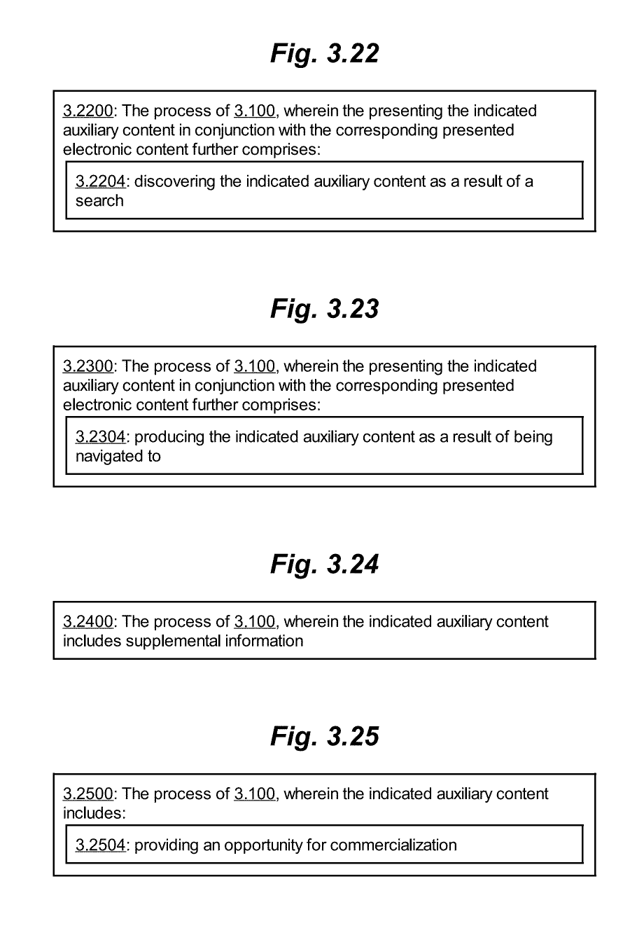

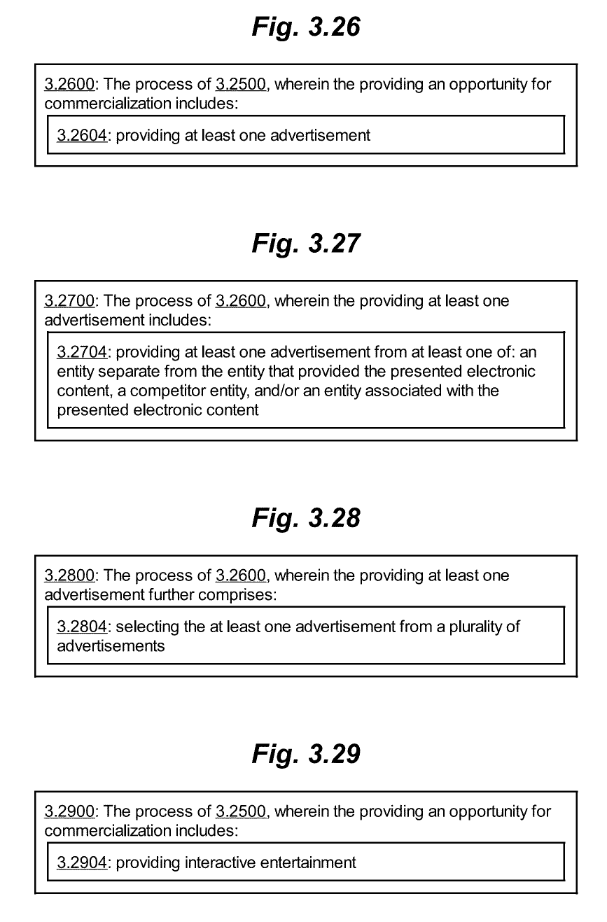

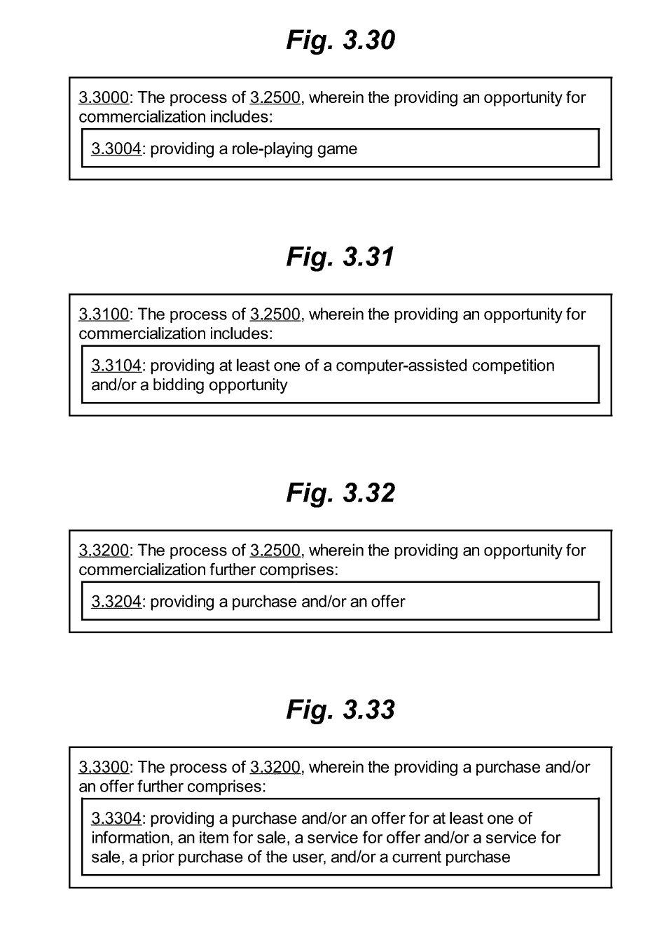

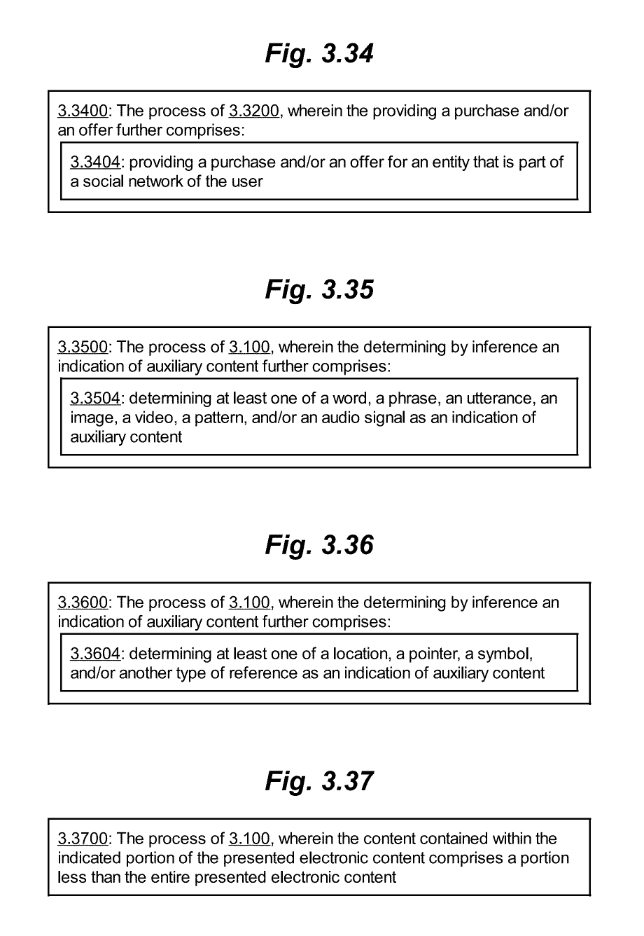

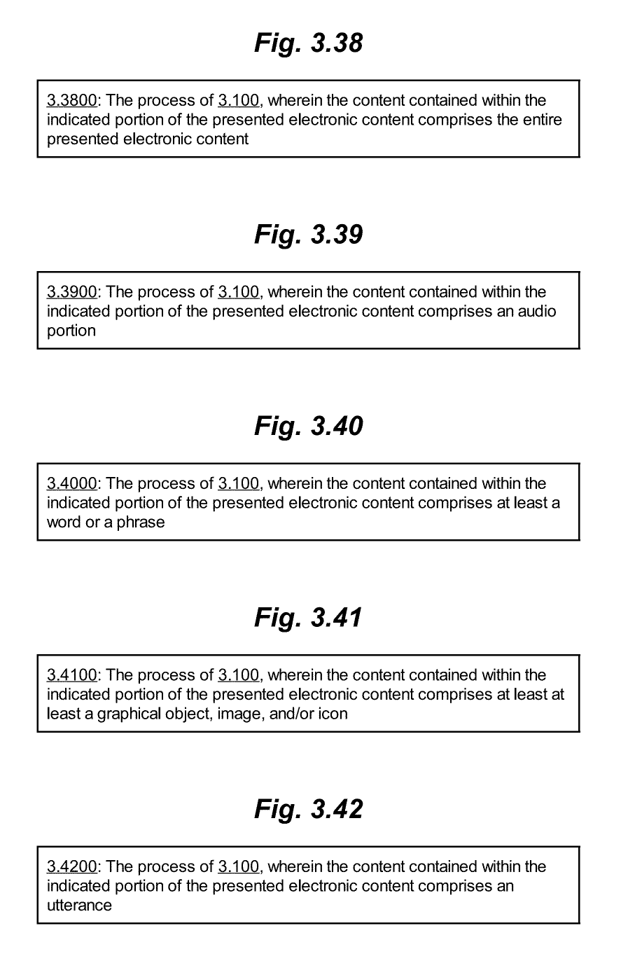

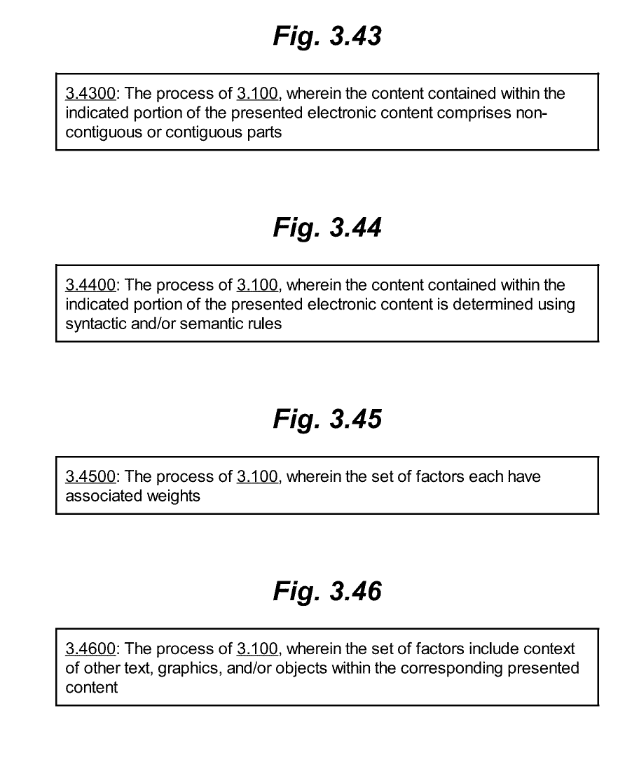

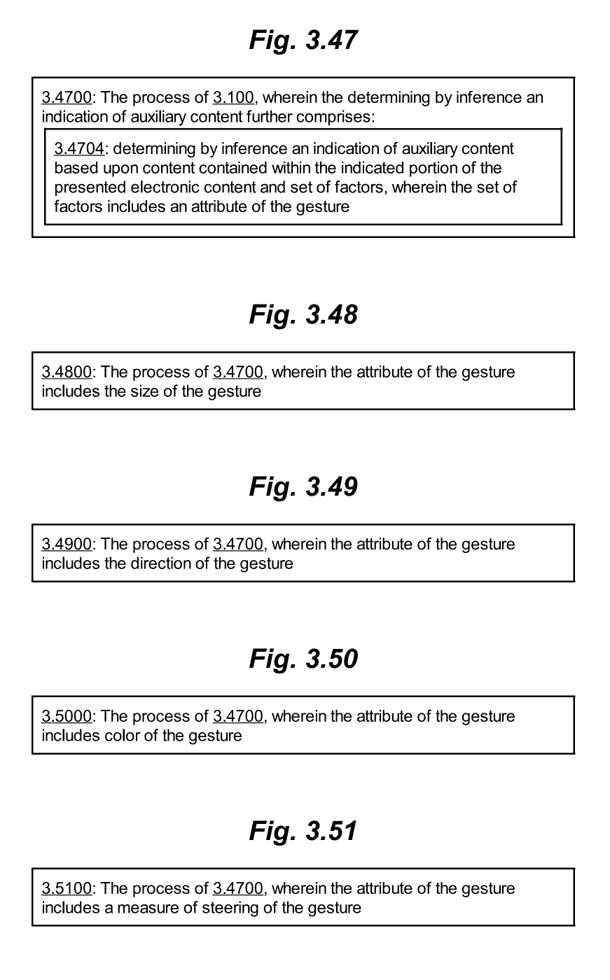

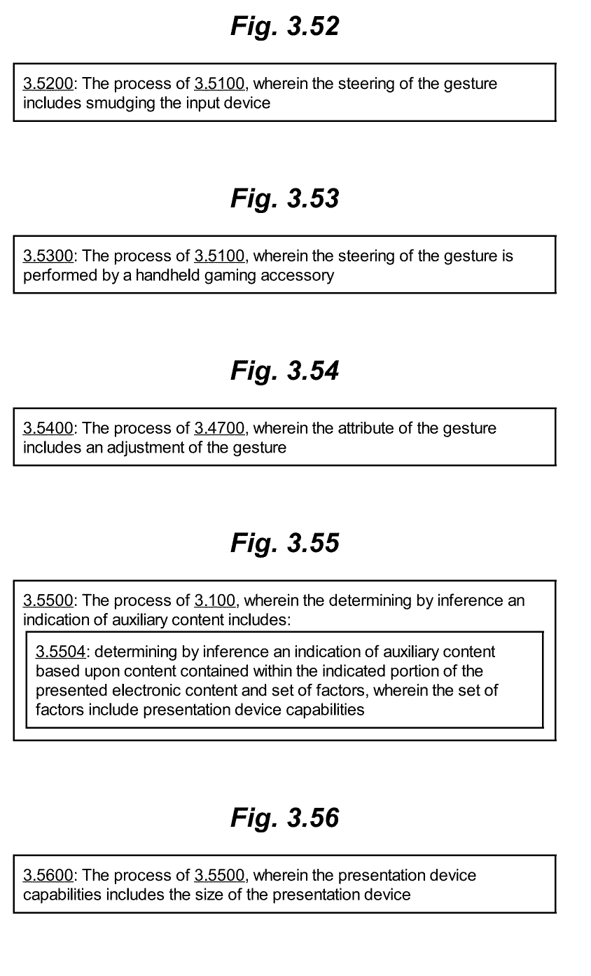

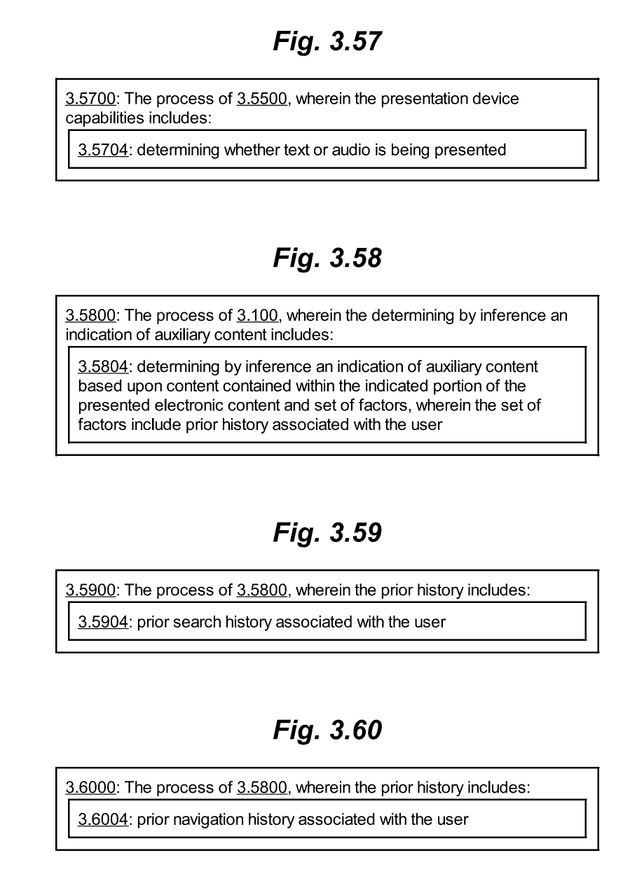

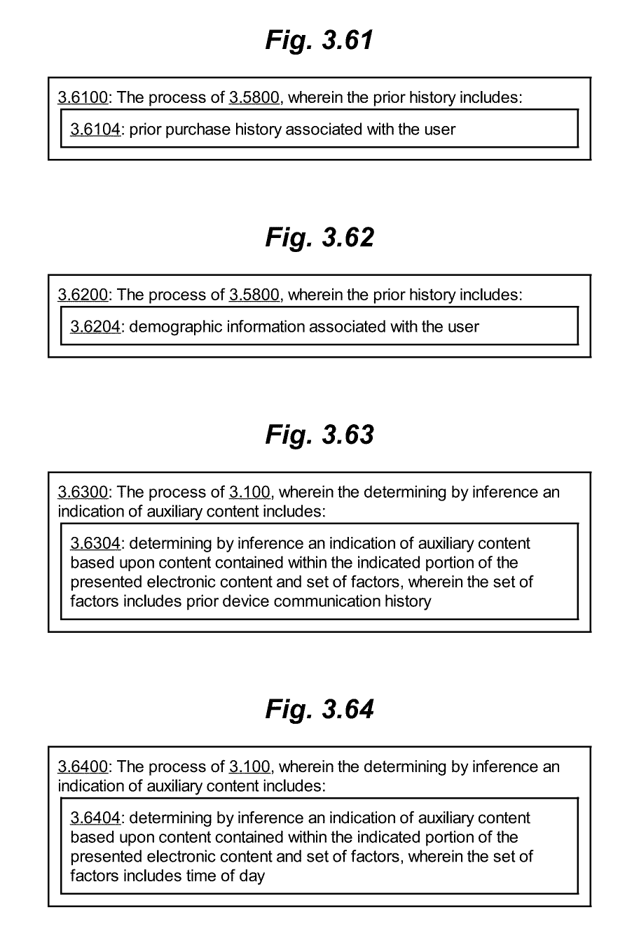

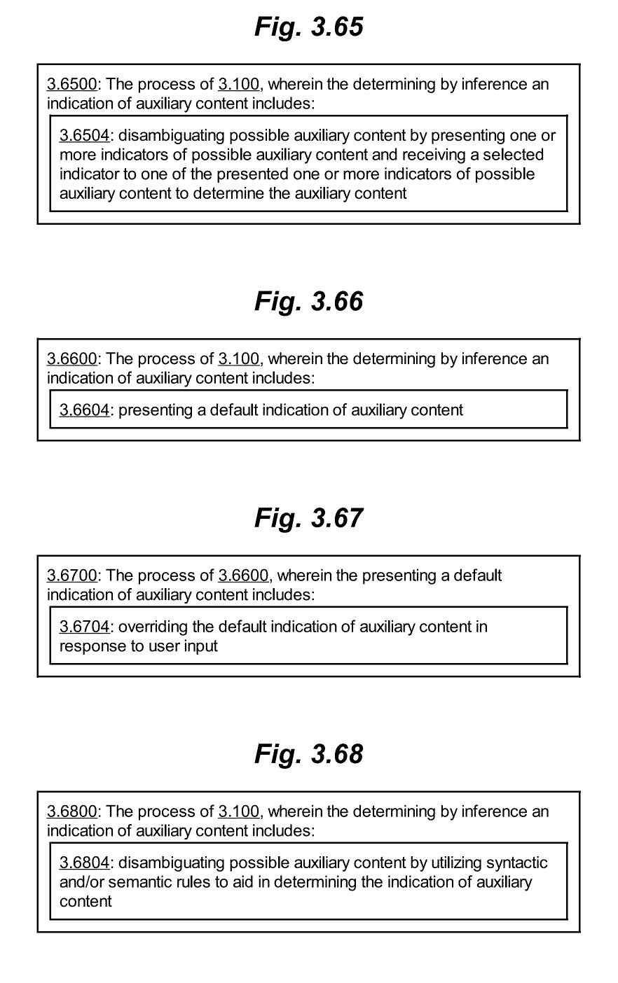

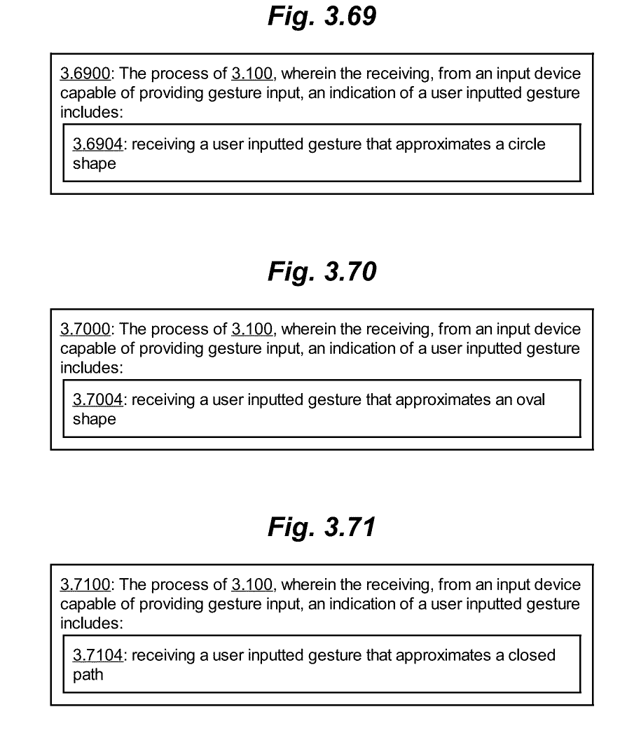

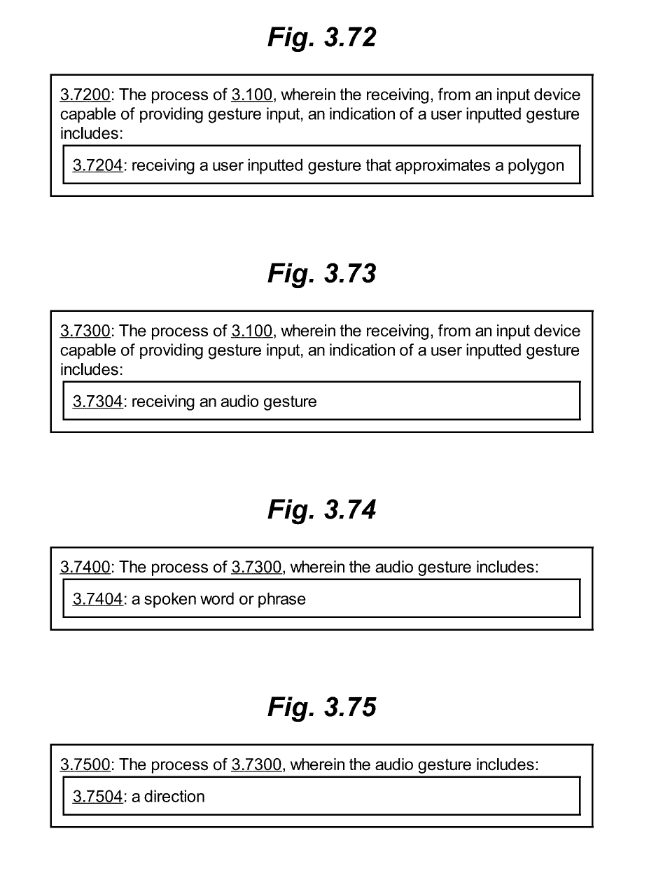

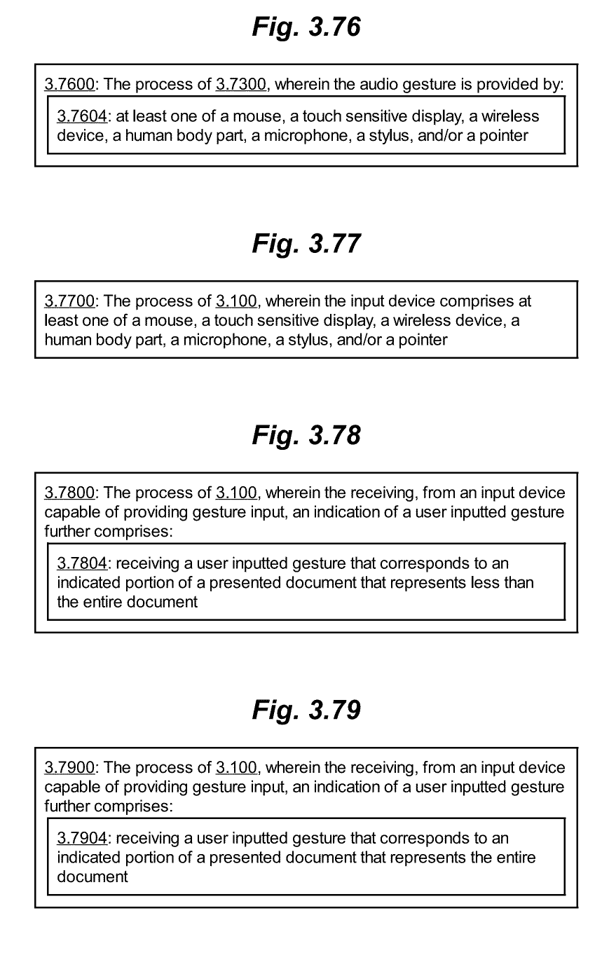

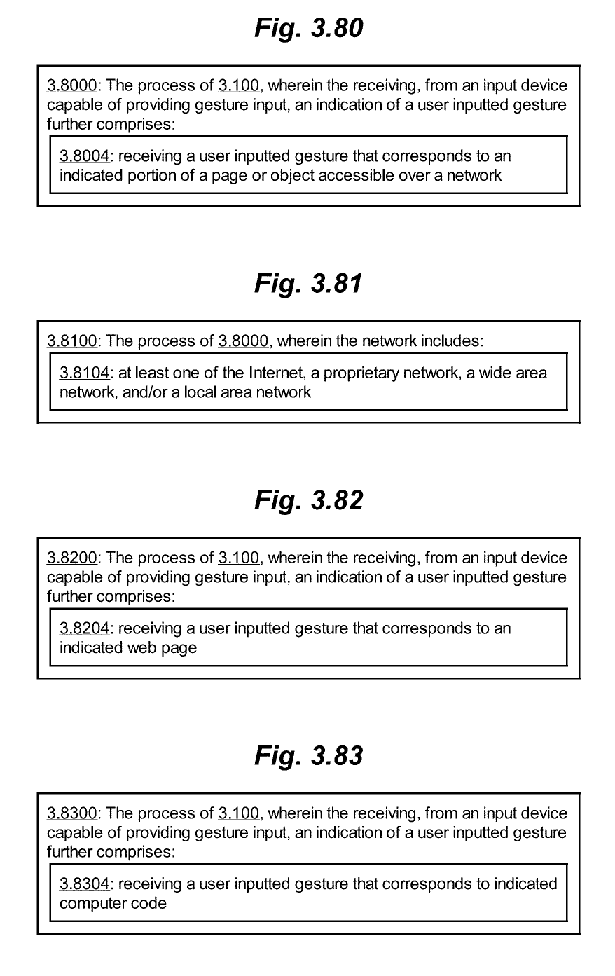

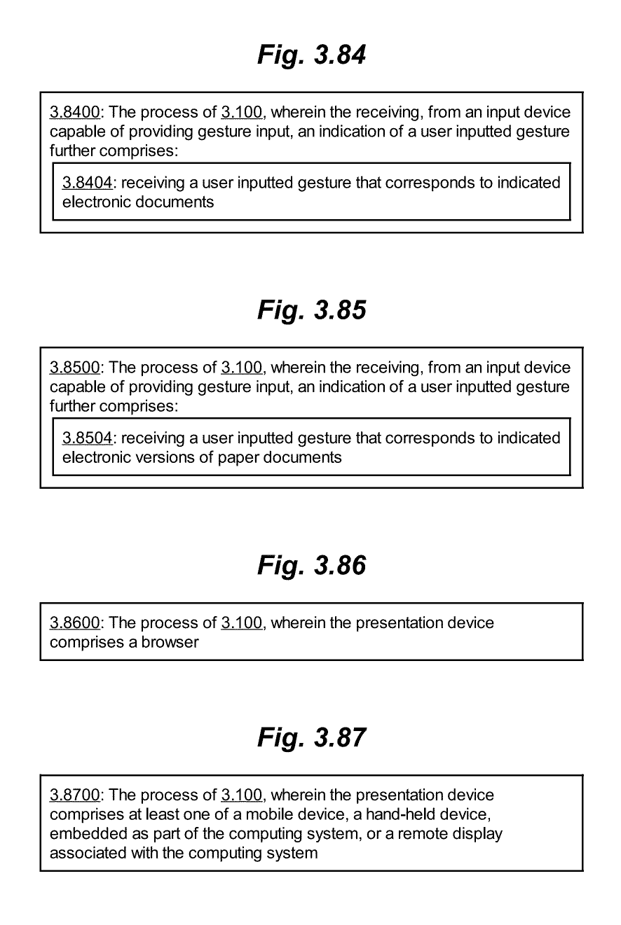

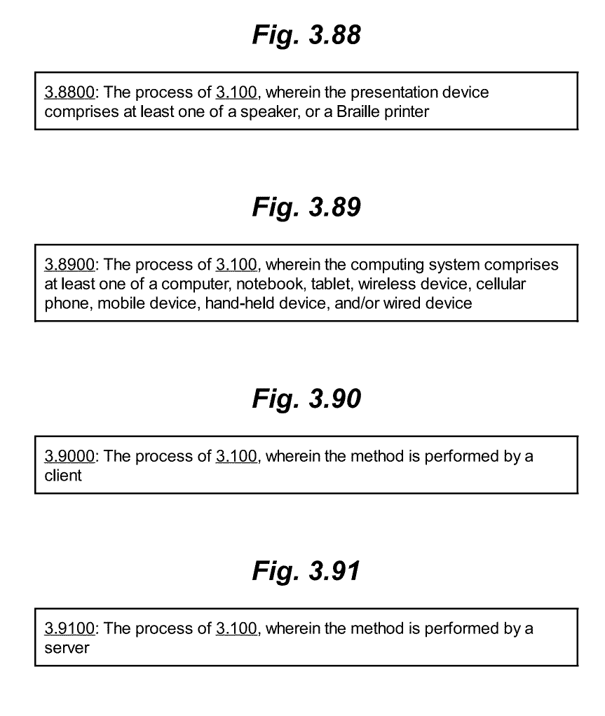

FIGS. 3.1-3.91 are example flow diagrams of various example logic that may be used to implement embodiments of a Gesture Based Content Presentation System (GBCPS). The example logic will be described with respect to the example components of example embodiments of a GBCPS as described above with respect to FIGS. 1A-2. However, it is to be understood that the flows and logic may be executed in a number of other environments, systems, and contexts, and/or in modified versions of those described. In addition, various logic blocks (e.g., operations, events, activities, or the like) may be illustrated in a “box-within-a-box” manner. Such illustrations may indicate that the logic in an internal box may comprise an optional example embodiment of the logic illustrated in one or more (containing) external boxes. However, it is to be understood that internal box logic may be viewed as independent logic separate from any associated external boxes and may be performed in other sequences or concurrently.

FIG. 3.1 is an example flow diagram of example logic in a computing system for presenting auxiliary content in a manner that provides contextual orientation to a user. More particularly, FIG. 3.1 illustrates a process 3.100 that includes operations performed by or at the following block(s).

At block 3.103, the process performs receiving, from an input device capable of providing gesture input, an indication of a user inputted gesture that corresponds to an indicated portion of electronic content presented via a presentation device associated with the computing system. This logic may be performed, for example, by the input module 111 of the GBCPS 110 described with reference to FIG. 2 by receiving (e.g., obtaining, getting, extracting, and so forth), from an input device capable of providing gesture input (e.g., devices 20*), an indication of a user inputted gesture that corresponds to an indicated portion (e.g., indicated portion 25) on electronic content presented via a presentation device (e.g., 20*) associated with the computing system 100. Different logic of the gesture input detection and resolution module 210, such as the audio handling logic, graphics handling logic, natural language processing, and/or gesture identification and attribute processing logic may be used to assist in this receiving block. The indicated portion may be formed from contiguous or composed of separate non-contiguous parts, for example, a title with a disconnected sentence. In addition, the indicated portion may represent the entire body of electronic content presented to the user or a part. Also as described elsewhere, the gestural input may be of different forms, including, for example, a circle, an oval, a closed path, a polygon, and the like. The gesture may be from a pointing device, for example, a mouse, laser pointer, a body part, and the like, or from a source of auditory input.

At block 3.108, the process performs determining by inference an indication of auxiliary content, based upon content contained within the indicated portion of the presented electronic content and a set of factors. This logic may be performed, for example, by the auxiliary content determination module 112 of the GBCPS 110 described with reference to FIG. 2. The auxiliary content module 112 may use a factor determination module 113 to determine a set of factors (e.g., the context of the gesture, the user, or of the presented content, prior history associated with the user or the system, attributes of the gestures, and the like) to use, in addition to determining what content has been indicated by the gesture, in order to determine an indication (e.g., a reference to, what, etc.) of auxiliary content. The content contained within the indicated portion of the presented electronic content may be anything, for example, a word, phrase, utterance, video, image, or the like.

At block 3.112, the process performs presenting the indicated auxiliary content in conjunction with the corresponding presented electronic content as an auxiliary presentation that accompanies at least a portion of the corresponding presented electronic content, therein providing visual and/or auditory context for the auxiliary content. This logic may be performed, for example, by the presentation module 114 of the GBCPS 110 described with reference to FIG. 2. As described in detail elsewhere, the indicated auxiliary content may include any type of content that can be shown to or navigated to by the user such as any type of auxiliary, supplemental, or other content. For example, the auxiliary content may include advertising, webpages, code, images, audio clips, video clips, speech, opportunities for commercialization such as a product or service offer or sale, competitions, or the like. The content may be presented (e.g., shown, displayed, played back, outputted, rendered, illustrated, or the like) as overlaid content or juxtaposed to the already presented electronic content, using additional presentation constructs (e.g., windows, frames, panes, dialog boxes, or the like) or within already presented constructs. In some cases, the user is navigated to the auxiliary content being presented by, for example, changing the user's focus point on the presentation device. In some embodiments at least a portion (e.g., some or all) of the originally presented content (from which the gesture was made) is also presented in order to provide visual and/or auditory context. For example, some indication of gestured text may be shown at the same time as the auxiliary content in order to show the user a correspondence between the gestured content and the new content. FIGS. 1B-1G show different examples of the many ways of presenting the auxiliary content in conjunction with the corresponding electronic content to maintain context.

FIG. 3.2 is an example flow diagram of example logic illustrating an example embodiment of process 3.100 of FIG. 3.1. More particularly, FIG. 3.2 illustrates a process 3.200 that includes the process 3.100, wherein the presenting the indicated auxiliary content in conjunction with the corresponding presented electronic content includes operations performed by or at the following block(s).

At block 3.204, the process performs presenting the auxiliary content as a visual overlay on a portion of the presented electronic content. This logic may be performed, for example, by the presentation module 114 of the GBCPS 110 described with reference to FIG. 2. The overlay may be in any form including a pane, window, menu, dialog, frame, etc. and may partially or totally obscure the underlying presented content.

FIG. 3.3 is an example flow diagram of example logic illustrating an example embodiment of process 3.200 of FIG. 3.2. More particularly, FIG. 3.3 illustrates a process 3.300 that includes the process 3.200, wherein the presenting the auxiliary content as a visual overlay includes operations performed by or at the following block(s).

At block 3.304, the process performs making the visual overlay visible using animation techniques. This logic may be performed, for example, by the presentation module 114 of the GBCPS 110 described with reference to FIG. 2. Animation techniques may include any type of animation technique appropriate for the presentation, including, for example, moving a presentation construct from one portion of a presentation device to another, zooming, wiggling, giving the appearance of flying, other types of movement, and the like. The animation techniques may include leaving trailing foot print information for the user to see the animation, may be of varying speeds, involve different shapes, sounds, color, or the like.

FIG. 3.4 is an example flow diagram of example logic illustrating an example embodiment of process 3.200 of FIG. 3.2. More particularly, FIG. 3.4 illustrates a process 3.400 that includes the process 3.200, wherein the receiving, from an input device capable of providing gesture input, an indication of a user inputted gesture includes operations performed by or at the following block(s).

At block 3.404, the process performs causing the overlay to appear to slide from one side of the presentation device onto the presented content. This logic may be performed, for example, by the presentation module 114 of the GBCPS 110 described with reference to FIG. 2. The overlay may be a window, frame, popup, dialog box, or any other presentation construct that may be made gradually more visible as it is moved into the visible presentation area. Once there, the presentation construct may obscure, not obscure, or partially obscure the other presented content. Sliding may include moving smoothly or not. The side of the presentation device may be the physical edge or a virtual edge.

FIG. 3.5 is an example flow diagram of example logic illustrating an example embodiment of process 3.400 of FIG. 3.4. More particularly, FIG. 3.5 illustrates a process 3.500 that includes the process 3.400 and which further includes operations performed by or at the following block(s).

At block 3.504, the process performs displaying sliding artifacts to demonstrate that the overlay is sliding. This logic may be performed, for example, by the presentation module 114 of the GBCPS 110 described with reference to FIG. 2. In some embodiments the process includes showing artifacts as the overlay is sliding into place in order to illustrate movement. Artifacts may be portions or edges of the overlay, repeated as the overlay is moved, such as those shown in FIGS. 1C and 1D.

FIG. 3.6 is an example flow diagram of example logic illustrating an example embodiment of process 3.200 of FIG. 3.2. More particularly, FIG. 3.6 illustrates a process 3.600 that includes the process 3.200, wherein the presenting the auxiliary content as a visual overlay includes operations performed by or at the following block(s).

At block 3.604, the process performs presenting the overlay as a rectangular overlay.

FIG. 3.7 is an example flow diagram of example logic illustrating an example embodiment of process 3.200 of FIG. 3.2. More particularly, FIG. 3.7 illustrates a process 3.700 that includes the process 3.200, wherein the presenting the auxiliary content as a visual overlay includes operations performed by or at the following block(s).

At block 3.704, the process performs presenting the overlay as a non-rectangular overlay.

FIG. 3.8 is an example flow diagram of example logic illustrating an example embodiment of process 3.200 of FIG. 3.2. More particularly, FIG. 3.8 illustrates a process 3.800 that includes the process 3.200, wherein the presenting the auxiliary content as a visual overlay includes operations performed by or at the following block(s).

At block 3.804, the process performs presenting the overlay in a manner that resembles the shape of the auxiliary content. This logic may be performed, for example, by the presentation module 114 of the GBCPS 110 described with reference to FIG. 2. In some embodiments the overlay is shaped to approximately or partially follow the contour of the auxiliary content. For example, if the auxiliary content is a product image, the overlay may have edges that follow the contour of product displayed in the image.

FIG. 3.9 is an example flow diagram of example logic illustrating an example embodiment of process 3.200 of FIG. 3.2. More particularly, FIG. 3.9 illustrates a process 3.900 that includes the process 3.200, wherein the presenting the auxiliary content as a visual overlay includes operations performed by or at the following block(s).

At block 3.904, the process performs presenting the overlay as a transparent overlay. This logic may be performed, for example, by the presentation module 114 of the GBCPS 110 described with reference to FIG. 2. In some embodiments the overlay is implemented to be transparent so that some portion or all of the content under the overlay shows through. Transparency techniques such as bitblt filters may be used.

FIG. 3.10 is an example flow diagram of example logic illustrating an example embodiment of process 3.200 of FIG. 3.2. More particularly, FIG. 3.10 illustrates a process 3.1000 that includes the process 3.200, wherein the presenting the auxiliary content as a visual overlay includes operations performed by or at the following block(s).

At block 3.1004, the process performs presenting the overlay wherein the background of the overlay is a different color than the background of the portion of the corresponding presented electronic content. This logic may be performed, for example, by the presentation module 114 of the GBCPS 110 described with reference to FIG. 2. In some embodiments the background (e.g., what lies beneath and around the image or text displayed in the overlay) is a different color so that is potentially easier to distinguish from the presented content, such as the indication of the gestured input.

FIG. 3.11 is an example flow diagram of example logic illustrating an example embodiment of process 3.200 of FIG. 3.2. More particularly, FIG. 3.11 illustrates a process 3.1100 that includes the process 3.200, wherein the presenting the auxiliary content as a visual overlay includes operations performed by or at the following block(s).

At block 3.1104, the process performs presenting the overlay wherein the overlay appears to occupy only a portion of a presentation construct used to present the corresponding presented electronic content. This logic may be performed, for example, by the presentation module 114 of the GBCPS 110 described with reference to FIG. 2. The portion occupied may be a small or large area of the presentation construct (e.g., window, frame, pane, or dialog box) and may be some or all of the presentation construct.

FIG. 3.12 is an example flow diagram of example logic illustrating an example embodiment of process 3.200 of FIG. 3.2. More particularly, FIG. 3.12 illustrates a process 3.1200 that includes the process 3.200, wherein the presenting the auxiliary content as a visual overlay includes operations performed by or at the following block(s).

At block 3.1204, the process performs presenting the overlay wherein the overlay is constructed from information from a social network associated with the user. This logic may be performed, for example, by the presentation module 114 of the GBCPS 110 described with reference to FIG. 2. For example, the overlay may be colored, shaped, or the type of overlay or layout chosen based upon preferences of the user noted in the user's social network or preferred by the user's contacts in the user's social network.

FIG. 3.13 is an example flow diagram of example logic illustrating an example embodiment of process 3.100 of FIG. 3.1. More particularly, FIG. 3.13 illustrates a process 3.1300 that includes the process 3.100, wherein the presenting the indicated auxiliary content in conjunction with the corresponding presented electronic content further comprises operations performed by or at the following block(s).

At block 3.1304, the process performs presenting the auxiliary content in at least one of an auxiliary window, pane, frame, and/or other auxiliary presentation construct. This logic may be performed, for example, by the presentation module 114 of the GBCPS 110 described with reference to FIG. 2. Once generated, the auxiliary presentation construct may be presented in an animated fashion, overlaid upon other content, placed non-contiguously or juxtaposed to other content.

FIG. 3.14 is an example flow diagram of example logic illustrating an example embodiment of process 3.1300 of FIG. 3.13. More particularly, FIG. 3.14 illustrates a process 3.1400 that includes the process 3.1300, wherein the presenting the auxiliary content further comprises operations performed by or at the following block(s).

At block 3.1404, the process performs presenting the auxiliary content in an auxiliary presentation construct separated from the corresponding presented electronic content. For example, the auxiliary content may be presented in a separate window or frame to enable the user to see the original content in addition to the auxiliary content (such as an advertisement). See, for example, FIG. 1F. The separate construct may be overlaid or completely distant and distinct from the presented electronic content.

FIG. 3.15 is an example flow diagram of example logic illustrating an example embodiment of process 3.1300 of FIG. 3.13. More particularly, FIG. 3.15 illustrates a process 3.1500 that includes the process 3.1300, wherein the presenting the auxiliary content further comprises operations performed by or at the following block(s).

At block 3.1504, the process performs presenting the auxiliary content in an auxiliary presentation construct juxtaposed to the corresponding presented electronic content. For example, the auxiliary content may be presented in a separate window or frame to enable the user to see the original content alongside the auxiliary content (such as an advertisement). See, for example, FIG. 1G.

FIG. 3.16 is an example flow diagram of example logic illustrating an example embodiment of process 3.100 of FIG. 3.1. More particularly, FIG. 3.16 illustrates a process 3.1600 that includes the process 3.100, wherein the presenting the indicated auxiliary content in conjunction with the corresponding presented electronic content further comprises operations performed by or at the following block(s).

At block 3.1604, the process performs presenting the auxiliary content based upon a social network associated with the user. This logic may be performed, for example, by the presentation module 114 of the GBCPS 110 described with reference to FIG. 2. For example, the type and or content presentation may be selected based upon preferences of the user noted in the user's social network or those preferred by the user's contacts in the user's social network. For example, if the user's “friends” insist on all advertisements being shown in separate windows, then the auxiliary content for this user may be shown (by default) that way as well.

FIG. 3.17 is an example flow diagram of example logic illustrating an example embodiment of process 3.100 of FIG. 3.1. More particularly, FIG. 3.17 illustrates a process 3.1700 that includes the process 3.100, wherein the presenting the indicated auxiliary content in conjunction with the corresponding presented electronic content includes operations performed by or at the following block(s).

At block 3.1704, the process performs preserving near-simultaneous visibility and/or audibility of at least a portion of the corresponding presented electronic content. Near-simultaneous visibility and/or audibility may include presenting the auxiliary content at about the same time and/or location as the presented electronic content.

FIG. 3.18 is an example flow diagram of example logic illustrating an example embodiment of process 3.100 of FIG. 3.1. More particularly, FIG. 3.18 illustrates a process 3.1800 that includes the process 3.100, wherein the presenting the indicated auxiliary content in conjunction with the corresponding presented electronic content includes operations performed by or at the following block(s).

At block 3.1804, the process performs preserving contemporaneous, concurrent, and/or coinciding visibility and/or audibility of at least a portion of the corresponding presented electronic content. Preserving (e.g., keeping, showing, etc.) may include presenting the auxiliary content while being able to see and/or hear the presented electronic content. The timing and or placement may be immediate or separate by small increments of time, but sufficient to present both to the user from a practical standpoint.

FIG. 3.19 is an example flow diagram of example logic illustrating an example embodiment of process 3.100 of FIG. 3.1. More particularly, FIG. 3.19 illustrates a process 3.1900 that includes the process 3.100, wherein the at least a portion of the corresponding presented electronic content comprises a portion of a web site.

FIG. 3.20 is an example flow diagram of example logic illustrating an example embodiment of process 3.100 of FIG. 3.1. More particularly, FIG. 3.20 illustrates a process 3.2000 that includes the process 3.100, wherein the at least a portion of the corresponding presented electronic content comprises a portion of code.

FIG. 3.21 is an example flow diagram of example logic illustrating an example embodiment of process 3.100 of FIG. 3.1. More particularly, FIG. 3.21 illustrates a process 3.2100 that includes the process 3.100, wherein the at least a portion of the corresponding presented electronic content comprises a portion of an electronic document. For example, the portion of the document may include a portion of text (e.g., a title or an abstract), a portion of an image (e.g., a set of pixels, frames, or a defined area, and/or a portion of an audio clip (e.g., a set of snippets) or the like.

FIG. 3.22 is an example flow diagram of example logic illustrating an example embodiment of process 3.100 of FIG. 3.1. More particularly, FIG. 3.22 illustrates a process 3.2200 that includes the process 3.100, wherein the presenting the indicated auxiliary content in conjunction with the corresponding presented electronic content further comprises operations performed by or at the following block(s).

At block 3.2204, the process performs discovering the indicated auxiliary content as a result of a search. This logic may be performed, for example, by the auxiliary content determination module 112 of the GBCPS 110 described with reference to FIG. 2. The search may include any type of boolean based or natural language search that results in the determination (e.g., finding, locating, surmising, discovering, and the like) of auxiliary content.

FIG. 3.23 is an example flow diagram of example logic illustrating an example embodiment of process 3.100 of FIG. 3.1. More particularly, FIG. 3.23 illustrates a process 3.2300 that includes the process 3.100, wherein the presenting the indicated auxiliary content in conjunction with the corresponding presented electronic content further comprises operations performed by or at the following block(s).

At block 3.2304, the process performs producing the indicated auxiliary content as a result of being navigated to. This logic may be performed, for example, by the auxiliary content determination module 112 of the GBCPS 110 described with reference to FIG. 2. Upon the user navigating to (e.g., changing his or her input or output focus to) content, the auxiliary content can be produced (e.g., generated, found, located, discovered, and the like) for example, from a third party source, such as a data repository, an advertising service, etc.

FIG. 3.24 is an example flow diagram of example logic illustrating an example embodiment of process 3.100 of FIG. 3.1. More particularly, FIG. 3.24 illustrates a process 3.2400 that includes the process 3.100, wherein the indicated auxiliary content includes supplemental information. Supplemental information may include any type (e.g., textual, audio, visual, or the like) of data from any source.

FIG. 3.25 is an example flow diagram of example logic illustrating an example embodiment of process 3.100 of FIG. 3.1. More particularly, FIG. 3.25 illustrates a process 3.2500 that includes the process 3.100, wherein the indicated auxiliary content includes operations performed by or at the following block(s).

At block 3.2504, the process performs providing an opportunity for commercialization. This logic may be performed, for example, by the opportunity for commercialization module 205 of the auxiliary content determination module 112 of the GBCPS 110 described with reference to FIG. 2. The opportunity for commercialization may involve any sort of content that gives the user or the system an opportunity for something to be purchased or offered for purchase or for any other sort of reason (e.g., survey, statistics, etc.) involving commerce. In this case the auxiliary content may include an indication of something that can be used for commercialization such as an advertisement, a web site that sells products, a bidding opportunity, a certificate, products, services, or the like.

FIG. 3.26 is an example flow diagram of example logic illustrating an example embodiment of process 3.2500 of FIG. 3.25. More particularly, FIG. 3.26 illustrates a process 3.2600 that includes the process 3.2500, wherein the providing an opportunity for commercialization includes operations performed by or at the following block(s).

At block 3.2604, the process performs providing at least one advertisement. In some embodiments the advertisement may be provided by a remote tool connected via the network to the GBCPS 110 such as a third party advertising system (e.g. system 43) or server. The advertisement may be any type of electronic advertisement including for example, text, images, sound, etc.

FIG. 3.27 is an example flow diagram of example logic illustrating an example embodiment of process 3.2600 of FIG. 3.26. More particularly, FIG. 3.27 illustrates a process 3.2700 that includes the process 3.2600, wherein the providing at least one advertisement includes operations performed by or at the following block(s).

At block 3.2704, the process performs providing at least one advertisement from at least one of: an entity separate from the entity that provided the presented electronic content, a competitor entity, and/or an entity associated with the presented electronic content. The entity associated with the presented electronic content may be, for example, GBCPS 110 and the advertisement from the auxiliary content 40. Advertisements may be supplied directly or indirectly as indicators to advertisements that can be served by server computing systems. The entity separate from the entity that provide the presented electronic content may be, for example, a third party or a competitor entity whose content is accessible through third party auxiliary content 43.

FIG. 3.28 is an example flow diagram of example logic illustrating an example embodiment of process 3.2600 of FIG. 3.26. More particularly, FIG. 3.28 illustrates a process 3.2800 that includes the process 3.2600, wherein the providing at least one advertisement further comprises operations performed by or at the following block(s).

At block 3.2804, the process performs selecting the at least one advertisement from a plurality of advertisements. The advertisement may be a direct or indirect indication of an advertisement that is somehow supplemental to the content indicated by the indicated portion of the gesture. When a third party server, such as a third party advertising system, is used to supply the auxiliary content a plurality of advertisements may be delivered (e.g., forwarded, sent, communicated, etc.) to the GBCPS 110 before being presented by the GBCPS 110.

FIG. 3.29 is an example flow diagram of example logic illustrating an example embodiment of process 3.2500 of FIG. 3.25. More particularly, FIG. 3.29 illustrates a process 3.2900 that includes the process 3.2500, wherein the providing an opportunity for commercialization includes operations performed by or at the following block(s).

At block 3.2904, the process performs providing interactive entertainment. The interactive entertainment may include, for example, a computer game, an on-line quiz show, a lottery, a movie to watch, and so forth.

FIG. 3.30 is an example flow diagram of example logic illustrating an example embodiment of process 3.2500 of FIG. 3.25. More particularly, FIG. 3.30 illustrates a process 3.3000 that includes the process 3.2500, wherein the providing an opportunity for commercialization includes operations performed by or at the following block(s).

At block 3.3004, the process performs providing a role-playing game. A role-playing game may include, for example, an online multi-player role playing game.

FIG. 3.31 is an example flow diagram of example logic illustrating an example embodiment of process 3.2500 of FIG. 3.25. More particularly, FIG. 3.31 illustrates a process 3.3100 that includes the process 3.2500, wherein the providing an opportunity for commercialization includes operations performed by or at the following block(s).

At block 3.3104, the process performs providing at least one of a computer-assisted competition and/or a bidding opportunity. The bidding opportunity, for example, a competition or gambling event, etc., may be computer based, computer-assisted, and/or manual.

FIG. 3.32 is an example flow diagram of example logic illustrating an example embodiment of process 3.2500 of FIG. 3.25. More particularly, FIG. 3.32 illustrates a process 3.3200 that includes the process 3.2500, wherein the providing an opportunity for commercialization further comprises operations performed by or at the following block(s).

At block 3.3204, the process performs providing a purchase and/or an offer. The purchase or offer may take any form, for example, a book advertisement, or a web page, and may be for products and/or services.

FIG. 3.33 is an example flow diagram of example logic illustrating an example embodiment of process 3.3200 of FIG. 3.32. More particularly, FIG. 3.33 illustrates a process 3.3300 that includes the process 3.3200, wherein the providing a purchase and/or an offer further comprises operations performed by or at the following block(s).

At block 3.3304, the process performs providing a purchase and/or an offer for at least one of information, an item for sale, a service for offer and/or a service for sale, a prior purchase of the user, and/or a current purchase. Any type of information, item, or service (online or offline, machine generated or human generated) can be offered and/or purchased in this manner. If human generated the advertisement may be to a computer representation of the human generated service, for example, a contract or a calendar entry, or the like.

FIG. 3.34 is an example flow diagram of example logic illustrating an example embodiment of process 3.3200 of FIG. 3.32. More particularly, FIG. 3.34 illustrates a process 3.3400 that includes the process 3.3200, wherein the providing a purchase and/or an offer further comprises operations performed by or at the following block(s).

At block 3.3404, the process performs providing a purchase and/or an offer for an entity that is part of a social network of the user. The purchase may be related to (e.g., associated with, directed to, mentioned by, a contact directly or indirectly related to, etc.) someone that belongs to a social network associated with the user, for example through the one or more networks 30.

FIG. 3.35 is an example flow diagram of example logic illustrating an example embodiment of process 3.100 of FIG. 3.1. More particularly, FIG. 3.35 illustrates a process 3.3500 that includes the process 3.100, wherein the determining by inference an indication of auxiliary content further comprises operations performed by or at the following block(s).

At block 3.3504, the process performs determining at least one of a word, a phrase, an utterance, an image, a video, a pattern, and/or an audio signal as an indication of auxiliary content. The logic may be performed by any one of the modules of the GBCPS 110. For example, the disambiguation module 208 and/or the opportunity for commercialization module 205 of the may determine auxiliary content (e.g., an advertisement, web page, or the like) and return an indication in the form of a word, phrase, utterance (e.g., a sound not necessarily comprehensible as a word), image, video, pattern, or audio signal.

FIG. 3.36 is an example flow diagram of example logic illustrating an example embodiment of process 3.100 of FIG. 3.1. More particularly, FIG. 3.36 illustrates a process 3.3600 that includes the process 3.100, wherein the determining by inference an indication of auxiliary content further comprises operations performed by or at the following block(s).

At block 3.3604, the process performs determining at least one of a location, a pointer, a symbol, and/or another type of reference as an indication of auxiliary content. The logic may be performed by any one of the modules of the GBCPS 110. In this case, the indication is one of a location, a pointer, a symbol, (e.g., an absolute or relative location, a location in memory locally or remotely, or the like) intended to enable the GBNS to find, obtain, or locate the auxiliary content in order to cause it to be presented.

FIG. 3.37 is an example flow diagram of example logic illustrating an example embodiment of process 3.100 of FIG. 3.1. More particularly, FIG. 3.37 illustrates a process 3.3700 that includes the process 3.100, wherein the content contained within the indicated portion of the presented electronic content comprises a portion less than the entire presented electronic content. This logic may be performed, for example, by the gesture input detection and resolution module 210 of the input module 111 of the GBCPS 110 described with reference to FIG. 2. The content determined to be contained within (e.g., represented by, indicated, etc.) the gestured portion may include for example only a portion of a presented content, such as a title and abstract of an electronically presented document.

FIG. 3.38 is an example flow diagram of example logic illustrating an example embodiment of process 3.100 of FIG. 3.1. More particularly, FIG. 3.38 illustrates a process 3.3800 that includes the process 3.100, wherein the content contained within the indicated portion of the presented electronic content comprises the entire presented electronic content. This logic may be performed, for example, by the gesture input detection and resolution module 210 of the input module 111 of the GBCPS 110 described with reference to FIG. 2. The content determined to be contained within (e.g., represented by, indicated, etc.) the gestured portion may include for the entire presented content, such as a whole document.

FIG. 3.39 is an example flow diagram of example logic illustrating an example embodiment of process 3.100 of FIG. 3.1. More particularly, FIG. 3.39 illustrates a process 3.3900 that includes the process 3.100, wherein the content contained within the indicated portion of the presented electronic content comprises an audio portion. This logic may be performed, for example, by the gesture input detection and resolution module 210 of the input module 111 of the GBCPS 110 described with reference to FIG. 2. For example, the gesture input detection and resolution module 210 may be configured to include an audio handling module (not shown) for handling gesture input by way of audio devices such as microphone 20b. The audio portion may be, for example, a spoken title of a presented document.

FIG. 3.40 is an example flow diagram of example logic illustrating an example embodiment of process 3.100 of FIG. 3.1. More particularly, FIG. 3.40 illustrates a process 3.4000 that includes the process 3.100, wherein the content contained within the indicated portion of the presented electronic content comprises at least a word or a phrase. This logic may be performed, for example, by the gesture input detection and resolution module 210 of the input module 111 of the GBCPS 110 described with reference to FIG. 2. For example, the gesture input detection and resolution module 210 may be configured to include a natural language processing module to detect whether a gesture is meant to indicate a word, a phrase, a sentence, a paragraph, or some other portion of presented electronic content using techniques such as syntactic and/or semantic analysis of the content. The word or phrase may be any word or phrase located in or indicated by the electronically presented content.

FIG. 3.41 is an example flow diagram of example logic illustrating an example embodiment of process 3.100 of FIG. 3.1. More particularly, FIG. 3.41 illustrates a process 3.4100 that includes the process 3.100, wherein the content contained within the indicated portion of the presented electronic content comprises at least at least a graphical object, image, and/or icon. This logic may be performed, for example, by the gesture input detection and resolution module 210 of the input module 111 of the GBCPS 110 described with reference to FIG. 2. For example, the gesture input detection and resolution module 210 may be configured to include a graphics handling module to handle the association of gestures to graphics located or indicated by the presented content (such as an icon, image, movie, still, sequence of frames, etc.).

FIG. 3.42 is an example flow diagram of example logic illustrating an example embodiment of process 3.100 of FIG. 3.1. More particularly, FIG. 3.42 illustrates a process 3.4200 that includes the process 3.100, wherein the content contained within the indicated portion of the presented electronic content comprises an utterance. This logic may be performed, for example, by the gesture input detection and resolution module 210 of the input module 111 of the GBCPS 110 described with reference to FIG. 2. For example, the gesture input detection and resolution module 210 may be configured to include an audio handling module (not shown) for handling gesture input by way of audio devices such as microphone 20b. The utterance may be, for example, a spoken word of a presented document, or a command, or a sound.

FIG. 3.43 is an example flow diagram of example logic illustrating an example embodiment of process 3.100 of FIG. 3.1. More particularly, FIG. 3.43 illustrates a process 3.4300 that includes the process 3.100, wherein the content contained within the indicated portion of the presented electronic content comprises non-contiguous or contiguous parts. This logic may be performed, for example, by the gesture input detection and resolution module 210 of the input module 111 of the GBCPS 110 described with reference to FIG. 2. For example, the contiguous parts may represent a continuous are of the presented content, such as a sentence, a portion of a paragraph, a sequence of images, or the like. Non-contiguous parts may include separate portions of the presented content that together comprise the indicated portion, such as a title and an abstract, a paragraph and the name of an author, a disconnected image and a spoken sentence, or the like.

FIG. 3.44 is an example flow diagram of example logic illustrating an example embodiment of process 3.100 of FIG. 3.1. More particularly, FIG. 3.44 illustrates a process 3.4400 that includes the process 3.100, wherein the content contained within the indicated portion of the presented electronic content is determined using syntactic and/or semantic rules. This logic may be performed, for example, by the gesture input detection and resolution module 210 of the input module 111 of the GBCPS 110 described with reference to FIG. 2. For example, the gesture input detection and resolution module 210 may be configured to include a natural language processing module to detect whether a gesture is meant to indicate a word, a phrase, a sentence, a paragraph, or some other portion of presented electronic content using techniques such as syntactic and/or semantic analysis of the content. The word or phrase may be any word or phrase located in or indicated by the electronically presented content.

FIG. 3.45 is an example flow diagram of example logic illustrating an example embodiment of process 3.100 of FIG. 3.1. More particularly, FIG. 3.45 illustrates a process 3.4500 that includes the process 3.100, wherein the set of factors each have associated weights. This logic may be performed, for example, by the factor determination module 113 of the GBCPS 110 described with reference to FIG. 2. For example, In some embodiments some attributes of the gesture may be more important, hence weighted more heavily, than other attributes, such as the prior navigation history of the user. Any form of weighting, whether explicit or implicit (e.g., numeric, discreet values, adjectives, or the like) may be used.

FIG. 3.46 is an example flow diagram of example logic illustrating an example embodiment of process 3.100 of FIG. 3.1. More particularly, FIG. 3.46 illustrates a process 3.4600 that includes the process 3.100, wherein the set of factors include context of other text, graphics, and/or objects within the corresponding presented content. This logic may be performed, for example, by the current context determination module 233 of the factor determination module 113 of the GBCPS 110 described with reference to FIG. 2 to determine (e.g., retrieve, designate, resolve, etc.) context related information from the currently presented content, including other text, audio, graphics, and/or objects.

FIG. 3.47 is an example flow diagram of example logic illustrating an example embodiment of process 3.100 of FIG. 3.1. More particularly, FIG. 3.47 illustrates a process 3.4700 that includes the process 3.100, wherein the determining by inference an indication of auxiliary content further comprises operations performed by or at the following block(s).

At block 3.4704, the process performs determining by inference an indication of auxiliary content based upon content contained within the indicated portion of the presented electronic content and set of factors, wherein the set of factors includes an attribute of the gesture. This logic may be performed, for example, by the gesture attributes determination module 237 of the factor determination module 113 of the GBCPS 110 described with reference to FIG. 2 to determine (e.g., retrieve, designate, resolve, etc.) context related information from the attributes of the gesture itself (e.g., color, size, direction, shape, and so forth).

FIG. 3.48 is an example flow diagram of example logic illustrating an example embodiment of process 3.4700 of FIG. 3.47. More particularly, FIG. 3.48 illustrates a process 3.4800 that includes the process 3.4700, wherein the attribute of the gesture includes the size of the gesture. Size of the gesture may include, for example, width and/or length, and other measurements appropriate to the input device 20*.

FIG. 3.49 is an example flow diagram of example logic illustrating an example embodiment of process 3.4700 of FIG. 3.47. More particularly, FIG. 3.49 illustrates a process 3.4900 that includes the process 3.4700, wherein the attribute of the gesture includes the direction of the gesture. Direction of the gesture may include, for example, up or down, east or west, and other measurements or commands appropriate to the input device 20*.

FIG. 3.50 is an example flow diagram of example logic illustrating an example embodiment of process 3.4700 of FIG. 3.47. More particularly, FIG. 3.50 illustrates a process 3.5000 that includes the process 3.4700, wherein the attribute of the gesture includes color of the gesture. Color of the gesture may include, for example, a pen and/or ink color as well as other measurements appropriate to the input device 20*.

FIG. 3.51 is an example flow diagram of example logic illustrating an example embodiment of process 3.4700 of FIG. 3.47. More particularly, FIG. 3.51 illustrates a process 3.5100 that includes the process 3.4700, wherein the attribute of the gesture includes a measure of steering of the gesture. Steering of the gesture may occur when, for example, an initial gesture is indicated (e.g., on a mobile device) and the user desires to correct or nudge it in a certain direction.

FIG. 3.52 is an example flow diagram of example logic illustrating an example embodiment of process 3.5100 of FIG. 3.51. More particularly, FIG. 3.52 illustrates a process 3.5200 that includes the process 3.5100, wherein the steering of the gesture includes smudging the input device. Smudging of the gesture may occur when, for example, an initial gesture is indicated (e.g., on a mobile device) and the user desires to correct or nudge it in a certain direction by, for example smudging the gesture using for example, a finger. This type of action may be particularly useful on a touch screen input device.

FIG. 3.53 is an example flow diagram of example logic illustrating an example embodiment of process 3.5100 of FIG. 3.51. More particularly, FIG. 3.53 illustrates a process 3.5300 that includes the process 3.5100, wherein the steering of the gesture is performed by a handheld gaming accessory. In this case the steering is performed by a handheld gaming accessory such as a particular type of input device 20*. For example, the gaming accessory may include a joy stick, a handheld controller, or the like.

FIG. 3.54 is an example flow diagram of example logic illustrating an example embodiment of process 3.4700 of FIG. 3.47. More particularly, FIG. 3.54 illustrates a process 3.5400 that includes the process 3.4700, wherein the attribute of the gesture includes an adjustment of the gesture. Once a gesture has been made, it may be adjusted (e.g., modified, extended, smeared, smudged, redone) by any mechanism, including, for example, adjusting the gesture itself, or, for example, by modifying what the gesture indicates, for example, using a context menu, selecting a portion of the indicated gesture, and so forth.

FIG. 3.55 is an example flow diagram of example logic illustrating an example embodiment of process 3.100 of FIG. 3.1. More particularly, FIG. 3.55 illustrates a process 3.5500 that includes the process 3.100, wherein the determining by inference an indication of auxiliary content includes operations performed by or at the following block(s).

At block 3.5504, the process performs determining by inference an indication of auxiliary content based upon content contained within the indicated portion of the presented electronic content and set of factors, wherein the set of factors include presentation device capabilities. This logic may be performed, for example, by the system attributes determination module 234 of the factor determination module 113 of the GBCPS 110 described with reference to FIG. 2. Presentation device capabilities may include, for example, whether the device is connected to speakers or a network such as the Internet, the size, whether the device supports color, is a touch screen, and so forth.

FIG. 3.56 is an example flow diagram of example logic illustrating an example embodiment of process 3.5500 of FIG. 3.55. More particularly, FIG. 3.56 illustrates a process 3.5600 that includes the process 3.5500, wherein the presentation device capabilities includes the size of the presentation device. Presentation device capabilities may include, for example, whether the device is connected to speakers or a network such as the Internet, the size of the device, whether the device supports color, is a touch screen, and so forth.

FIG. 3.57 is an example flow diagram of example logic illustrating an example embodiment of process 3.5500 of FIG. 3.55. More particularly, FIG. 3.57 illustrates a process 3.5700 that includes the process 3.5500, wherein the presentation device capabilities includes operations performed by or at the following block(s).

At block 3.5704, the process performs determining whether text or audio is being presented. In addition to determining whether text or audio is being presented, presentation device capabilities may include, for example, whether the device is connected to speakers or a network such as the Internet, the size of the device, whether the device supports color, is a touch screen, and so forth.

FIG. 3.58 is an example flow diagram of example logic illustrating an example embodiment of process 3.100 of FIG. 3.1. More particularly, FIG. 3.58 illustrates a process 3.5800 that includes the process 3.100, wherein the determining by inference an indication of auxiliary content includes operations performed by or at the following block(s).

At block 3.5804, the process performs determining by inference an indication of auxiliary content based upon content contained within the indicated portion of the presented electronic content and set of factors, wherein the set of factors include prior history associated with the user. This logic may be performed, for example, by the prior history determination module 232 of the factor determination module 113 of the GBCPS 110 described with reference to FIG. 2. In some embodiments, prior history may be associated with (e.g., coincident with, related to, appropriate to, etc.) the user, for example, prior purchase, navigation, or search history or demographic information.

FIG. 3.59 is an example flow diagram of example logic illustrating an example embodiment of process 3.5800 of FIG. 3.58. More particularly, FIG. 3.59 illustrates a process 3.5900 that includes the process 3.5800, wherein the prior history includes operations performed by or at the following block(s).

At block 3.5904, the process performs prior search history associated with the user. Factors such as what content the user has reviewed and looked for may be considered. Other factors may be considered as well.

FIG. 3.60 is an example flow diagram of example logic illustrating an example embodiment of process 3.5800 of FIG. 3.58. More particularly, FIG. 3.60 illustrates a process 3.6000 that includes the process 3.5800, wherein the prior history includes operations performed by or at the following block(s).

At block 3.6004, the process performs prior navigation history associated with the user. Factors such as what content the user has reviewed and looked for may be considered. Other factors may be considered as well.

FIG. 3.61 is an example flow diagram of example logic illustrating an example embodiment of process 3.5800 of FIG. 3.58. More particularly, FIG. 3.61 illustrates a process 3.6100 that includes the process 3.5800, wherein the prior history includes operations performed by or at the following block(s).

At block 3.6104, the process performs prior purchase history associated with the user. Factors such as what products and/or services the user has bought or considered buying (determined, for example, by what the user has viewed) may be considered. Other factors may be considered as well.

FIG. 3.62 is an example flow diagram of example logic illustrating an example embodiment of process 3.5800 of FIG. 3.58. More particularly, FIG. 3.62 illustrates a process 3.6200 that includes the process 3.5800, wherein the prior history includes operations performed by or at the following block(s).

At block 3.6204, the process performs demographic information associated with the user. This logic may be performed, for example, by the prior history determination module 232 of the factor determination module 113 of the GBCPS 110 described with reference to FIG. 2 to determine a set of criteria based upon the demographic history associated with the user. Factors such as what the age, gender, location, citizenship, religious preferences (if specified) may be considered. Other factors may be considered as well.

FIG. 3.63 is an example flow diagram of example logic illustrating an example embodiment of process 3.100 of FIG. 3.1. More particularly, FIG. 3.63 illustrates a process 3.6300 that includes the process 3.100, wherein the determining by inference an indication of auxiliary content includes operations performed by or at the following block(s).

At block 3.6304, the process performs determining by inference an indication of auxiliary content based upon content contained within the indicated portion of the presented electronic content and set of factors, wherein the set of factors includes prior device communication history. This logic may be performed, for example, by the system attributes determination module 234 of the factor determination module 113 of the GBCPS 110 described with reference to FIG. 2. Prior device communication history may include aspects such as how often the computing system running the GBCPS 110 has been connected to the Internet, whether multiple client devices are connected to it—some times, at all times, etc., and how often the computing system is connected with various remote search capabilities.

FIG. 3.64 is an example flow diagram of example logic illustrating an example embodiment of process 3.100 of FIG. 3.1. More particularly, FIG. 3.64 illustrates a process 3.6400 that includes the process 3.100, wherein the determining by inference an indication of auxiliary content includes operations performed by or at the following block(s).

At block 3.6404, the process performs determining by inference an indication of auxiliary content based upon content contained within the indicated portion of the presented electronic content and set of factors, wherein the set of factors includes time of day. This logic may be performed, for example, by the factor determination module 113 of the GBCPS 110 described with reference to FIG. 2 to determine time of day.

FIG. 3.65 is an example flow diagram of example logic illustrating an example embodiment of process 3.100 of FIG. 3.1. More particularly, FIG. 3.65 illustrates a process 3.6500 that includes the process 3.100, wherein the determining by inference an indication of auxiliary content includes operations performed by or at the following block(s).

At block 3.6504, the process performs disambiguating possible auxiliary content by presenting one or more indicators of possible auxiliary content and receiving a selected indicator to one of the presented one or more indicators of possible auxiliary content to determine the auxiliary content. This logic may be performed, for example, by the disambiguation module 208 of the auxiliary content determination module 112 of the GBCPS 110 described with reference to FIG. 2. Presenting the one or more indicators of possible auxiliary content allows a user 10* to select which next content to navigate to, especially in the case where there is some sort of ambiguity.

FIG. 3.66 is an example flow diagram of example logic illustrating an example embodiment of process 3.100 of FIG. 3.1. More particularly, FIG. 3.66 illustrates a process 3.6600 that includes the process 3.100, wherein the determining by inference an indication of auxiliary content includes operations performed by or at the following block(s).

At block 3.6604, the process performs presenting a default indication of auxiliary content. The GBCPS 110 may determine a default auxiliary content to navigate to (e.g., a web page concerning the most prominent entity in the indicated portion of the presented content) in the case of an ambiguous finding of auxiliary content.

FIG. 3.67 is an example flow diagram of example logic illustrating an example embodiment of process 3.6600 of FIG. 3.66. More particularly, FIG. 3.67 illustrates a process 3.6700 that includes the process 3.6600, wherein the presenting a default indication of auxiliary content includes operations performed by or at the following block(s).

At block 3.6704, the process performs overriding the default indication of auxiliary content in response to user input. The GBCPS 110 allows the user 10* to override an default auxiliary content presented in a variety of ways, including by specifying that no default content is to be presented. Overriding can take place as a configuration parameter of the system, upon the presentation of a set of possible selections of auxiliary content, or at other times.

FIG. 3.68 is an example flow diagram of example logic illustrating an example embodiment of process 3.100 of FIG. 3.1. More particularly, FIG. 3.68 illustrates a process 3.6800 that includes the process 3.100, wherein the determining by inference an indication of auxiliary content includes operations performed by or at the following block(s).

At block 3.6804, the process performs disambiguating possible auxiliary content by utilizing syntactic and/or semantic rules to aid in determining the indication of auxiliary content. As described elsewhere, NLP-based mechanisms may be employed to determine what a user means by a gesture and hence what auxiliary content may be meaningful.

FIG. 3.69 is an example flow diagram of example logic illustrating an example embodiment of process 3.100 of FIG. 3.1. More particularly, FIG. 3.69 illustrates a process 3.6900 that includes the process 3.100, wherein the receiving, from an input device capable of providing gesture input, an indication of a user inputted gesture includes operations performed by or at the following block(s).

At block 3.6904, the process performs receiving a user inputted gesture that approximates a circle shape. This logic may be performed, for example, by the device handlers 212 of the input module 111 of the GBCPS 110 described with reference to FIG. 2 to detect whether a received gesture is in a form that approximates a circle shape.

FIG. 3.70 is an example flow diagram of example logic illustrating an example embodiment of process 3.100 of FIG. 3.1. More particularly, FIG. 3.70 illustrates a process 3.7000 that includes the process 3.100, wherein the receiving, from an input device capable of providing gesture input, an indication of a user inputted gesture includes operations performed by or at the following block(s).

At block 3.7004, the process performs receiving a user inputted gesture that approximates an oval shape. This logic may be performed, for example, by the device handlers 212 of the input module 111 of the GBCPS 110 described with reference to FIG. 2 to detect whether a received gesture is in a form that approximates an oval shape.

FIG. 3.71 is an example flow diagram of example logic illustrating an example embodiment of process 3.100 of FIG. 3.1. More particularly, FIG. 3.71 illustrates a process 3.7100 that includes the process 3.100, wherein the receiving, from an input device capable of providing gesture input, an indication of a user inputted gesture includes operations performed by or at the following block(s).

At block 3.7104, the process performs receiving a user inputted gesture that approximates a closed path. This logic may be performed, for example, by the device handlers 212 of the input module 111 of the GBCPS 110 described with reference to FIG. 2 to detect whether a received gesture is in a form that approximates a closed path of points and/or line segments.

FIG. 3.72 is an example flow diagram of example logic illustrating an example embodiment of process 3.100 of FIG. 3.1. More particularly, FIG. 3.72 illustrates a process 3.7200 that includes the process 3.100, wherein the receiving, from an input device capable of providing gesture input, an indication of a user inputted gesture includes operations performed by or at the following block(s).

At block 3.7204, the process performs receiving a user inputted gesture that approximates a polygon. This logic may be performed, for example, by the device handlers 212 of the input module 111 of the GBCPS 110 described with reference to FIG. 2 to detect whether a received gesture is in a form that approximates a polygon.

FIG. 3.73 is an example flow diagram of example logic illustrating an example embodiment of process 3.100 of FIG. 3.1. More particularly, FIG. 3.73 illustrates a process 3.7300 that includes the process 3.100, wherein the receiving, from an input device capable of providing gesture input, an indication of a user inputted gesture includes operations performed by or at the following block(s).

At block 3.7304, the process performs receiving an audio gesture. This logic may be performed, for example, by the gesture input detection and resolution module 210 of the input module 111 of the GBCPS 110 described with reference to FIG. 2 to detect whether a received gesture is an audio gesture, such as received via audio device, microphone 20b.

FIG. 3.74 is an example flow diagram of example logic illustrating an example embodiment of process 3.7300 of FIG. 3.73. More particularly, FIG. 3.74 illustrates a process 3.7400 that includes the process 3.7300, wherein the audio gesture includes operations performed by or at the following block(s).

At block 3.7404, the process performs a spoken word or phrase. This logic may be performed, for example, by the gesture input detection and resolution module 210 of the input module 111 of the GBCPS 110 described with reference to FIG. 2 to detect whether a received audio gesture, such as received via audio device, microphone 20b, indicates (e.g., designates or otherwise selects) a word or phrase indicating some portion of the presented content.

FIG. 3.75 is an example flow diagram of example logic illustrating an example embodiment of process 3.7300 of FIG. 3.73. More particularly, FIG. 3.75 illustrates a process 3.7500 that includes the process 3.7300, wherein the audio gesture includes operations performed by or at the following block(s).

At block 3.7504, the process performs a direction. This logic may be performed, for example, by the gesture input detection and resolution module 210 of the input module 111 of the GBCPS 110 described with reference to FIG. 2 to detect whether a direction received from an audio input device, such as audio input device 20b. The direction may be a single letter, number, word, phrase, or any type of instruction or indication of where to move a cursor or locator device.

FIG. 3.76 is an example flow diagram of example logic illustrating an example embodiment of process 3.7300 of FIG. 3.73. More particularly, FIG. 3.76 illustrates a process 3.7600 that includes the process 3.7300, wherein the audio gesture is provided by operations performed by or at the following block(s).

At block 3.7604, the process performs at least one of a mouse, a touch sensitive display, a wireless device, a human body part, a microphone, a stylus, and/or a pointer. This logic may be performed, for example, by the gesture input detection and resolution module 210 of the input module 111 of the GBCPS 110 described with reference to FIG. 2 to detect and resolve audio gesture input from, for example, devices 20*.

FIG. 3.77 is an example flow diagram of example logic illustrating an example embodiment of process 3.100 of FIG. 3.1. More particularly, FIG. 3.77 illustrates a process 3.7700 that includes the process 3.100, wherein the input device comprises at least one of a mouse, a touch sensitive display, a wireless device, a human body part, a microphone, a stylus, and/or a pointer. This logic may be performed, for example, by the specific device handlers 212 of the input module 111 of the GBCPS 110 described with reference to FIG. 2 to detect and resolve gesture input from, for example, devices 20*. Other input devices may also be accommodated. Wireless devices may include devices such as cellular phones, notebooks, mobile devices, tablets, computers, remote controllers, and the like. Human body parts may include, for example, a head, a finger, an arm, a leg, and the like, especially useful for those challenged to provide gestures by other means. Touch sensitive displays may include, for example, touch sensitive screens that are part of other devices (e.g., in a computer or in a phone) or that are standalone devices.

FIG. 3.78 is an example flow diagram of example logic illustrating an example embodiment of process 3.100 of FIG. 3.1. More particularly, FIG. 3.78 illustrates a process 3.7800 that includes the process 3.100, wherein the receiving, from an input device capable of providing gesture input, an indication of a user inputted gesture further comprises operations performed by or at the following block(s).

At block 3.7804, the process performs receiving a user inputted gesture that corresponds to an indicated portion of a presented document that represents less than the entire document. This logic may be performed, for example, by the input module 111 of the GBCPS 110 described with reference to FIG. 2. The gesture may correspond, for example, to a portion of a document, such as a frame on a web page, a title of a document, or the like.

FIG. 3.79 is an example flow diagram of example logic illustrating an example embodiment of process 3.100 of FIG. 3.1. More particularly, FIG. 3.79 illustrates a process 3.7900 that includes the process 3.100, wherein the receiving, from an input device capable of providing gesture input, an indication of a user inputted gesture further comprises operations performed by or at the following block(s).

At block 3.7904, the process performs receiving a user inputted gesture that corresponds to an indicated portion of a presented document that represents the entire document. This logic may be performed, for example, by the input module 111 of the GBCPS 110 described with reference to FIG. 2. The gesture may correspond, for example, to a whole document, a web page, an entire code module, or the like.

FIG. 3.80 is an example flow diagram of example logic illustrating an example embodiment of process 3.100 of FIG. 3.1. More particularly, FIG. 3.80 illustrates a process 3.8000 that includes the process 3.100, wherein the receiving, from an input device capable of providing gesture input, an indication of a user inputted gesture further comprises operations performed by or at the following block(s).

At block 3.8004, the process performs receiving a user inputted gesture that corresponds to an indicated portion of a page or object accessible over a network. This logic may be performed, for example, by the input module 111 of the GBCPS 110 described with reference to FIG. 2. The indicated page or object may be accessible via a reference pointer of some nature (e.g., a hyperlink, a url, a filename, or the like).

FIG. 3.81 is an example flow diagram of example logic illustrating an example embodiment of process 3.8000 of FIG. 3.80. More particularly, FIG. 3.81 illustrates a process 3.8100 that includes the process 3.8000, wherein the network includes operations performed by or at the following block(s).

At block 3.8104, the process performs at least one of the Internet, a proprietary network, a wide area network, and/or a local area network. The network may include a public or private network, a wide area network such as the Internet, a local area network such as a network of computers connected via an Ethernet cable, and the like.

FIG. 3.82 is an example flow diagram of example logic illustrating an example embodiment of process 3.100 of FIG. 3.1. More particularly, FIG. 3.82 illustrates a process 3.8200 that includes the process 3.100, wherein the receiving, from an input device capable of providing gesture input, an indication of a user inputted gesture further comprises operations performed by or at the following block(s).

At block 3.8204, the process performs receiving a user inputted gesture that corresponds to an indicated web page. This logic may be performed, for example, by the input module 111 of the GBCPS 110 described with reference to FIG. 2. The portion (e.g., part, component, etc.) of the presented electronic content that is indicated by the gesture is a web page, such as content available from a server using HTTP. The web page may be part of the presented electronic content, directly (e.g., it is presented as part of the content) or indirectly (e.g., it is referred to by the presented electronic content.

FIG. 3.83 is an example flow diagram of example logic illustrating an example embodiment of process 3.100 of FIG. 3.1. More particularly, FIG. 3.83 illustrates a process 3.8300 that includes the process 3.100, wherein the receiving, from an input device capable of providing gesture input, an indication of a user inputted gesture further comprises operations performed by or at the following block(s).

At block 3.8304, the process performs receiving a user inputted gesture that corresponds to indicated computer code. This logic may be performed, for example, by the input module 111 of the GBCPS 110 described with reference to FIG. 2. The portion (e.g., part, component, etc.) of the presented electronic content that is indicated by the gesture is computer code. The code may be a resident part of the presented electronic content, directly (e.g., it is presented as part of the content) or indirectly (e.g., it is referred to by the presented electronic content.

FIG. 3.84 is an example flow diagram of example logic illustrating an example embodiment of process 3.100 of FIG. 3.1. More particularly, FIG. 3.84 illustrates a process 3.8400 that includes the process 3.100, wherein the receiving, from an input device capable of providing gesture input, an indication of a user inputted gesture further comprises operations performed by or at the following block(s).

At block 3.8404, the process performs receiving a user inputted gesture that corresponds to indicated electronic documents. This logic may be performed, for example, by the input module 111 of the GBCPS 110 described with reference to FIG. 2. The portion (e.g., part, component, etc.) of the presented electronic content that is indicated by the gesture corresponds to one or more documents (e.g., code, web pages, electronic documents, or the like). The documents may be part of the presented electronic content, directly (e.g., it is presented as part of the content) or indirectly (e.g., it is referred to by the presented electronic content.

FIG. 3.85 is an example flow diagram of example logic illustrating an example embodiment of process 3.100 of FIG. 3.1. More particularly, FIG. 3.85 illustrates a process 3.8500 that includes the process 3.100, wherein the receiving, from an input device capable of providing gesture input, an indication of a user inputted gesture further comprises operations performed by or at the following block(s).

At block 3.8504, the process performs receiving a user inputted gesture that corresponds to indicated electronic versions of paper documents. This logic may be performed, for example, by the input module 111 of the GBCPS 110 described with reference to FIG. 2. The portion (e.g., part, component, etc.) of the presented electronic content that is indicated by the gesture corresponds to one or more objects that are electronic versions (e.g., replicas, facsimiles, etc.) of paper documents. The electronic versions may be part of the presented electronic content, directly (e.g., it is presented as part of the content) or indirectly (e.g., it is referred to by the presented electronic content.

FIG. 3.86 is an example flow diagram of example logic illustrating an example embodiment of process 3.100 of FIG. 3.1. More particularly, FIG. 3.86 illustrates a process 3.8600 that includes the process 3.100, wherein the presentation device comprises a browser. This logic may be performed, for example, by the specific device handlers 212 of the input module 111 of the GBCPS 110 described with reference to FIG. 2.

FIG. 3.87 is an example flow diagram of example logic illustrating an example embodiment of process 3.100 of FIG. 3.1. More particularly, FIG. 3.87 illustrates a process 3.8700 that includes the process 3.100, wherein the presentation device comprises at least one of a mobile device, a hand-held device, embedded as part of the computing system, or a remote display associated with the computing system. This logic may be performed, for example, by the specific device handlers 212 of the input module 111 of the GBCPS 110 described with reference to FIG. 2.

FIG. 3.88 is an example flow diagram of example logic illustrating an example embodiment of process 3.100 of FIG. 3.1. More particularly, FIG. 3.88 illustrates a process 3.8800 that includes the process 3.100, wherein the presentation device comprises at least one of a speaker, or a Braille printer. This logic may be performed, for example, by the specific device handlers 212 of the input module 111 of the GBCPS 110 described with reference to FIG. 2.

FIG. 3.89 is an example flow diagram of example logic illustrating an example embodiment of process 3.100 of FIG. 3.1. More particularly, FIG. 3.89 illustrates a process 3.8900 that includes the process 3.100, wherein the computing system comprises at least one of a computer, notebook, tablet, wireless device, cellular phone, mobile device, hand-held device, and/or wired device. This logic may be performed, for example, by the input module 111 of the GBCPS 110 described with reference to FIG. 2.

FIG. 3.90 is an example flow diagram of example logic illustrating an example embodiment of process 3.100 of FIG. 3.1. More particularly, FIG. 3.90 illustrates a process 3.9000 that includes the process 3.100, wherein the method is performed by a client. As described earlier, a client may be hardware, software, or firmware, physical or virtual, and may be part or the whole of a computing system. A client may be an application or a device.

FIG. 3.91 is an example flow diagram of example logic illustrating an example embodiment of process 3.100 of FIG. 3.1. More particularly, FIG. 3.91 illustrates a process 3.9100 that includes the process 3.100, wherein the method is performed by a server. As described earlier, a server may be hardware, software, or firmware, physical or virtual, and may be part or the whole of a computing system. A server may be service as well as a system.

### Example Computing System

FIG. 4 is an example block diagram of an example computing system for practicing embodiments of a Gesture Based Content Presentation System as described herein. Note that a general purpose or a special purpose computing system suitably instructed may be used to implement an GBCPS, such as GBCPS 110 of FIG. 1H. Further, the GBCPS may be implemented in software, hardware, firmware, or in some combination to achieve the capabilities described herein.

The computing system 100 may comprise one or more server and/or client computing systems and may span distributed locations. In addition, each block shown may represent one or more such blocks as appropriate to a specific embodiment or may be combined with other blocks. Moreover, the various blocks of the GBCPS 110 may physically reside on one or more machines, which use standard (e.g., TCP/IP) or proprietary interprocess communication mechanisms to communicate with each other.

In the embodiment shown, computer system 100 comprises a computer memory (“memory”) 101, a display 402, one or more Central Processing Units (“CPU”) 403, Input/Output devices 404 (e.g., keyboard, mouse, CRT or LCD display, etc.), other computer-readable media 405, and one or more network connections 406. The GBCPS 110 is shown residing in memory 101. In other embodiments, some portion of the contents, some of, or all of the components of the GBCPS 110 may be stored on and/or transmitted over the other computer-readable media 405. The components of the GBCPS 110 preferably execute on one or more CPUs 403 and manage providing automatic navigation to auxiliary content, as described herein. Other code or programs 430 and potentially other data stores, such as data repository 420, also reside in the memory 101, and preferably execute on one or more CPUs 403. Of note, one or more of the components in FIG. 4 may not be present in any specific implementation. For example, some embodiments embedded in other software may not provide means for user input or display.

In a typical embodiment, the GBCPS 110 includes one or more input modules 111, one or more auxiliary content determination modules 112, one or more factor determination modules 113, and one or more presentation modules 114. In at least some embodiments, some data is provided external to the GBCPS 110 and is available, potentially, over one or more networks 30. Other and/or different modules may be implemented. In addition, the GBCPS 110 may interact via a network 30 with application or client code 455 that can absorb auxiliary content results or indicated gesture information, for example, for other purposes, one or more client computing systems or client devices 20*, and/or one or more third-party content provider systems 465, such as third party advertising systems or other purveyors of auxiliary content. Also, of note, the history data repository 44 may be provided external to the GBCPS 110 as well, for example in a knowledge base accessible over one or more networks 30.

In an example embodiment, components/modules of the GBCPS 110 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk, etc.), functional (e.g., ML, Lisp, Scheme, etc.), procedural (e.g., C, Pascal, Ada, Modula, etc.), scripting (e.g., Perl, Ruby, Python, JavaScript, VBScript, etc.), declarative (e.g., SQL, Prolog, etc.), etc.

The embodiments described above may also use well-known or proprietary synchronous or asynchronous client-server computing techniques. However, the various components may be implemented using more monolithic programming techniques as well, for example, as an executable running on a single CPU computer system, or alternately decomposed using a variety of structuring techniques known in the art, including but not limited to, multiprogramming, multithreading, client-server, or peer-to-peer, running on one or more computer systems each having one or more CPUs. Some embodiments are illustrated as executing concurrently and asynchronously and communicating using message passing techniques. Equivalent synchronous embodiments are also supported by an GBCPS implementation.

In addition, programming interfaces to the data stored as part of the GBCPS 110 (e.g., in the data repositories 44 and 41) can be available by standard means such as through C, C++, C#, Visual Basic.NET and Java APIs; libraries for accessing files, databases, or other data repositories; through scripting languages such as XML; or through Web servers, FTP servers, or other types of servers providing access to stored data. The repositories 44 and 41 may be implemented as one or more database systems, file systems, or any other method known in the art for storing such information, or any combination of the above, including implementation using distributed computing techniques.

Also the example GBCPS 110 may be implemented in a distributed environment comprising multiple, even heterogeneous, computer systems and networks. Different configurations and locations of programs and data are contemplated for use with techniques of described herein. In addition, the server and/or client components may be physical or virtual computing systems and may reside on the same physical system. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) etc. Other variations are possible. Also, other functionality could be provided by each component/module, or existing functionality could be distributed amongst the components/modules in different ways, yet still achieve the functions of an GBCPS.

Furthermore, in some embodiments, some or all of the components of the GBCPS 110 may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

All of the above U.S. patents, U.S. patent application publications, U.S. patent applications, foreign patents, foreign patent applications and non-patent publications referred to in this specification and/or listed in the Application Data Sheet, are incorporated herein by reference, in their entireties.

From the foregoing it will be appreciated that, although specific embodiments have been described herein for purposes of illustration, various modifications may be made without deviating from the spirit and scope of the claims. For example, the methods and systems for performing automatic navigation to auxiliary content discussed herein are applicable to other architectures other than a windowed or client-server architecture. Also, the methods and systems discussed herein are applicable to differing protocols, communication media (optical, wireless, cable, etc.) and devices (such as wireless handsets, electronic organizers, personal digital assistants, tablets, portable email machines, game machines, pagers, navigation devices such as GPS receivers, etc.).

1. A method in a computing system for presenting auxiliary content in a manner that provides contextual orientation to a user, the method comprising:
receiving, from an input device capable of providing gesture input, an indication of a user inputted gesture that corresponds to an indicated portion of electronic content presented via a presentation device associated with the computing system;
determining by inference an indication of auxiliary content, based upon content contained within the indicated portion of the presented electronic content and a set of factors; and
presenting the indicated auxiliary content in conjunction with the corresponding presented electronic content as an auxiliary presentation that accompanies at least a portion of the corresponding presented electronic content, therein providing visual and/or auditory context for the auxiliary content.

2. The method of claim 1, wherein the presenting the indicated auxiliary content in conjunction with the corresponding presented electronic content includes: presenting the auxiliary content as a visual overlay on a portion of the presented electronic content.

3. The method of claim 2, wherein the presenting the auxiliary content as a visual overlay includes: making the visual overlay visible using animation techniques.

4. The method of claim 2, wherein the receiving, from an input device capable of providing gesture input, an indication of a user inputted gesture includes: causing the overlay to appear to slide from one side of the presentation device onto the presented content.

5. The method of claim 4, further comprising: displaying sliding artifacts to demonstrate that the overlay is sliding.

6. The method of claim 2, wherein the presenting the auxiliary content as a visual overlay includes: presenting the overlay as a rectangular overlay.

7. The method of claim 2, wherein the presenting the auxiliary content as a visual overlay includes: presenting the overlay as a non-rectangular overlay.

8. The method of claim 2, wherein the presenting the auxiliary content as a visual overlay includes: presenting the overlay in a manner that resembles the shape of the auxiliary content.

9. The method of claim 2, wherein the presenting the auxiliary content as a visual overlay includes: presenting the overlay as a transparent overlay.

10. The method of claim 2, wherein the presenting the auxiliary content as a visual overlay includes: presenting the overlay wherein the background of the overlay is a different color than the background of the portion of the corresponding presented electronic content.

11. The method of claim 2, wherein the presenting the auxiliary content as a visual overlay includes: presenting the overlay wherein the overlay appears to occupy only a portion of a presentation construct used to present the corresponding presented electronic content.

12. The method of claim 2, wherein the presenting the auxiliary content as a visual overlay includes: presenting the overlay wherein the overlay is constructed from information from a social network associated with the user.

13. The method of claim 1, wherein the presenting the indicated auxiliary content in conjunction with the corresponding presented electronic content further comprises: presenting the auxiliary content in at least one of an auxiliary window, pane, frame, and/or other auxiliary presentation construct.

14. The method of claim 13, wherein the presenting the auxiliary content further comprises: presenting the auxiliary content in an auxiliary presentation construct separated from the corresponding presented electronic content.

15. The method of claim 13, wherein the presenting the auxiliary content further comprises: presenting the auxiliary content in an auxiliary presentation construct juxtaposed to the corresponding presented electronic content.

16. The method of claim 1, wherein the presenting the indicated auxiliary content in conjunction with the corresponding presented electronic content further comprises: presenting the auxiliary content based upon a social network associated with the user.

17. The method of claim 1, wherein the presenting the indicated auxiliary content in conjunction with the corresponding presented electronic content includes: preserving near-simultaneous visibility and/or audibility of at least a portion of the corresponding presented electronic content.

18. The method of claim 1, wherein the presenting the indicated auxiliary content in conjunction with the corresponding presented electronic content includes: preserving contemporaneous, concurrent, and/or coinciding visibility and/or audibility of at least a portion of the corresponding presented electronic content.

19. The method of claim 1, wherein the at least a portion of the corresponding presented electronic content comprises at least one of a portion of a web site, a portion of code, and/or a portion of an electronic document.

20.-21. (canceled)

22. The method of claim 1, wherein the presenting the indicated auxiliary content in conjunction with the corresponding presented electronic content further comprises: discovering the indicated auxiliary content as a result of a search.

23. The method of claim 1, wherein the presenting the indicated auxiliary content in conjunction with the corresponding presented electronic content further comprises: producing the indicated auxiliary content as a result of being navigated to.

24. The method of claim 1, wherein the indicated auxiliary content includes at least one of supplemental information, an opportunity for commercialization, and/or an advertisement.

25.-26. (canceled)

27. The method of claim 1, wherein the presenting the indicated auxiliary content includes providing at least one advertisement from at least one of: an entity separate from the entity that provided the presented electronic content, a competitor entity, and/or an entity associated with the presented electronic content.

28. The method of claim 1, wherein the presenting the indicated auxiliary content further comprises: selecting at least one advertisement from a plurality of advertisements.

29. The method of claim 1, wherein the presenting indicated auxiliary content includes providing an opportunity for commercialization and the providing an opportunity for commercialization includes: providing at least one of interactive entertainment, a role-playing game, a computer-assisted competition and/or a bidding opportunity, and/or a purchase and/or an offer.

30.-32. (canceled)

33. The method of claim 32, wherein the providing a purchase and/or an offer further comprises: providing a purchase and/or an offer for at least one of information, an item for sale, a service for offer and/or a service for sale, a prior purchase of the user, and/or a current purchase.

34. The method of claim 32, wherein the providing a purchase and/or an offer further comprises: providing a purchase and/or an offer for an entity that is part of a social network of the user.

35. The method of claim 1, wherein the determining by inference an indication of auxiliary content further comprises: determining at least one of a word, a phrase, an utterance, an image, a video, a pattern, and/or an audio signal as an indication of auxiliary content.

36. The method of claim 1, wherein the determining by inference an indication of auxiliary content further comprises: determining at least one of a location, a pointer, a symbol, and/or another type of reference as an indication of auxiliary content.

37. The method of claim 1, wherein the content contained within the indicated portion of the presented electronic content comprises a portion less than the entire presented electronic content or the entire presented electronic content.

38. (canceled)

39. The method of claim 1, wherein the content contained within the indicated portion of the presented electronic content comprises an audio portion, at least a word or a phrase, a graphical object, image, and/or icon, and/or an utterance.

40. The method of claim 1, wherein the content contained within the indicated portion of the presented electronic content comprises at least a word or a phrase.

41. The method of claim 1, wherein the content contained within the indicated portion of the presented electronic content comprises at least at least a graphical object, image, and/or icon.

42. The method of claim 1, where in the content contained within the indicated portion of the presented electronic content comprises an utterance.

43. The method of claim 1, wherein the content contained within the indicated portion of the presented electronic content comprises non-contaguous or contiguous parts.

44. The method of claim 1, wherein the content contained within the indicated portion of the presented electronic content is determined using syntactic and/or semantic rules.

45. The method of claim 1, wherein the set of factors each have associated weights.

46. The method of claim 1, wherein the set of factors include context of other text, graphics, and/or objects within the corresponding presented content and/or presentation device capabilities.

47. The method of claim 1, wherein the determining by inference an indication of auxiliary content further comprises: determining by inference an indication of auxiliary content based upon content contained within the indicated portion of the presented electronic content and set of factors, wherein the set of factors includes an attribute of the gesture.

48. The method of claim 47, wherein the attribute of the gesture includes at least one of a size of the gesture, a direction of the gesture, a color, and/or a measure of steering of the gesture, and/or an adjustment of the gesture.

49.-56. (canceled)

57. The method of claim 1, wherein the determining an indication of auxiliary content based upon content contained within the indicated portion includes: determining whether text or audio is being presented.

58. The method of claim 1, wherein the determining by inference an indication of auxiliary content includes: determining by inference an indication of auxiliary content based upon content contained within the indicated portion of the presented electronic content and set of factors, wherein the set of factors includes at least one of prior device communication history, time of day, and/or prior history associated with the user.

59. The method of claim 58, wherein the prior history associated with the user includes: at least one of prior search history associated with the user, prior navigation history associated with the user, prior purchase history associated with the user and/or demographic information associated with the user.

60.-64. (canceled)

65. The method of claim 1, wherein the determining by inference an indication of auxiliary content includes: disambiguating possible auxiliary content by at least one of presenting one or more indicators of possible auxiliary content and receiving a selected indicator to one of the presented one or more indicators of possible auxiliary content to determine the auxiliary content, presenting a default indication of auxiliary content, and/or utilizing syntactic and/or semantic rules to aid in determining the indication of auxiliary content.

66.-68. (canceled)

69. The method of claim 1, wherein the receiving, from an input device capable of providing gesture input, an indication of a user inputted gesture includes: receiving a user inputted gesture that approximates at least one of a circle shape, an oval shape, a closed path, and/or a polygon.

70.-72. (canceled)

73. The method of claim 1, wherein the receiving, from an input device capable of providing gesture input, an indication of a user inputted gesture includes: receiving an audio gesture.

74.-76. (canceled)

77. The method of claim 1, wherein the input device comprises at least one of a mouse, a touch sensitive display, a wireless device, a human body part, a microphone, a stylus, and/or a pointer.

78.-81. (canceled)

82. The method of claim 1, wherein the receiving, from an input device capable of providing gesture input, an indication of a user inputted gesture further comprises: receiving a user inputted gesture that corresponds to an indicated web page, an indicated portion of a page or object accessible over a network, indicated computer code, indicated electronic documents, and/or indicated electronic versions of paper documents.

83.-86. (canceled)

87. The method of claim 1, wherein the presentation device comprises at least one of a browser, a mobile device, a hand-held device, embedded as part of the computing system, a remote display associated with the computing system, and/or a speaker or a Braille printer.

88. (canceled)

89. The method of claim 1, wherein the computing system comprises at least one of a computer, notebook, tablet, wireless device, cellular phone, mobile device, hand-held device, and/or wired device.

90. The method of claim 1, wherein the method is performed by a client or by a server.

91.-273. (canceled)
